(19) United States
(12) Patent Application Publication
(10) Pub. No.: US 2017/0300184 A1
(43) Pub. Date: Oct. 19, 2017

(54) METHOD AND SYSTEM FOR PROVIDING AN INTUITIVE AND INTERACTIVE FINANCIAL TRANSACTION CATEGORIZATION DISPLAY

(71) Applicant: Intuit Inc., Mountain View, CA (US)

(72) Inventors: Justin Calles, San Francisco, CA (US); Jean-Luc Delpech, Los Altos Hills, CA (US); Scott Garten, San Jose, CA (US); Braden Young, San Francisco, CA (US)

(73) Assignee: Intuit Inc., Mountain View, CA (US)

(21) Appl. No.: 15/099,324

(22) Filed: Apr. 14, 2016

(51) Int. Cl. G06F 3/0482; G06Q 20/08; G06F 3/0488

(52) U.S. Cl. CPC G06F 3/0482; G06F 3/0488; G06Q 20/08

(57) ABSTRACT

An uncategorized financial transaction display includes a listing of uncategorized financial transactions and personal and business display regions, the personal uncategorized financial transaction display region being associated with a personal financial transaction category and a business uncategorized financial transaction display region being associated with a business financial transaction category. A user is provided the capability to categorize each of the uncategorized financial transactions by selecting an uncategorized financial transaction listed in the uncategorized financial transaction display and making a sweeping motion to either the personal or business display region of the uncategorized financial transaction display. Once a user makes a sweeping motion to either the personal or business display region, the user is provided sub-category options within the uncategorized financial transaction display and an indication of the tax ramifications of the selected categorization.

### BACKGROUND

Currently, several types of financial management systems are available to help an individual user obtain the user's financial data, process/analyze the user's financial data, and/or generate various customized financial reports and displays for the user.

Herein, a financial management system can be, but is not limited to, any data management system that gathers data associated with an individual, business, or other entity, including financial transactional data, from one or more sources, such as financial accounts and financial institutions, and/or has the capability to analyze and categorize at least part of the financial data. One specific illustrative example of financial management systems are small business financial management systems used by small businesses and/or self-employed users to track business related transactions and identify business related transactions that have associated tax ramifications.

While currently available financial management systems have proven to be effective and powerful tools, many users of financial management systems desire, and would greatly benefit from, very basic analysis, interaction, and displays showing how the user and/or business is spending money and allowing the user to easily categorized financial transactions with minimal data entry. This is particularly critical to users that interact with the financial management system via a mobile device. However, currently, it is often the case that the level of complexity, sophistication, and “granularity” of the categorizations, analysis, and displays associated with traditional financial management systems actually provide a user too much information and require far more interaction, attention, and mental analysis than the user actually wants to devote to managing their finances. In addition to being overly complicated, data and reports generated by currently available financial management systems are often presented to the user in relatively static and unengaging reports and displays that provide little or no opportunity for user interaction with the data and/or user modification.

This long standing problem in the technical fields of financial management, data display, and user experience has at least four significant undesirable results. First many users simply stop using the financial management system because, as noted, the process does not engage the user, and many users do not know how, or do not want to devote the time and energy required, to obtain information that is meaningful to the user.

Second, using currently available financial management systems, in order to modify or otherwise enter data associated with specific financial transactions such as categorization data, the user must often interact with multiple screens and enter data through a keyboard, or other input device, that is often burdensome and difficult to use. In addition, in a world rapidly becoming dominated by mobile systems, such as smart-phones, having to scroll through and interact with large amounts of often undesired analysis data and categorizations to determine a user's recent spending history and tax ramifications is not only burdensome, but is actually prone to erroneous data entry and analysis. This is because while a “qwerty” keyboard can be made to fit in a space less than 2″ wide, that doesn't make it easy or efficient to use. Consequently, the user is not actively engaged in the categorization process, and/or required to analyze their spending/tax situation. In addition, the data displayed and processed by currently available financial management systems is often not up to date, or is incomplete.

Third, currently available financial management systems often employ a hundred or more financial transaction categories, often defined by other parties, such as the IRS, and therefore users lose track of which financial transactions to select and what categories to apply, in the “haystack” of potentially hundreds of financial transaction categories that the user did not define.

Finally, the displays provided by currently available financial management systems are often not relevant, nor are they intuitive, and they do not actively engage the user in the process of analyzing and categorizing their financial transactions. As a result, the user is not encouraged to become an active participant in the user's financial activity and/or determining the tax or other ramifications of financial transactions.

As noted above, the long standing problem of presenting users their financial information in an efficient, relevant, intuitive, interactive, dynamic, and engaging way, and providing for easy and intuitive categorization of financial transactions, is a significant technical huddle. Consequently, both users and providers of financial management systems are detrimentally affected by this long standing problem in the technical fields of financial management, data display, and user experience.

What is needed is a method and system for providing users an intuitive and interactive financial transaction categorization display that allows users to intuitively and easily visualize their financial transactions, categorize their financial transactions, and understand the tax or other ramifications of their financial transactions in a relevant and engaging way.

### SUMMARY

Embodiments of the present disclosure address some of the shortcomings associated with prior art financial management systems and related displays by providing users an intuitive and interactive financial transaction categorization display.

In accordance with one embodiment, a user of a financial management system is provided the capability to categorize any uncategorized financial transactions by selecting an uncategorized financial transaction listed in an uncategorized financial transaction display and making a sweeping motion to either a first or second region of the uncategorized financial transaction display. In accordance with one embodiment, selection of a given uncategorized financial transaction followed by a sweeping motion swept to the first region of the uncategorized financial transaction display results in the given uncategorized financial transaction being automatically categorized as a member of first financial transaction category, such as, but not limited to a personal financial transaction category. In accordance with one embodiment, selection of a given uncategorized financial transaction followed by a sweeping motion swept to the second region of the uncategorized financial transaction display results in the given uncategorized financial transaction being automatically categorized as a member of second financial transaction category, such as, but not limited to a business financial transaction category.

In one embodiment, one or more financial transaction sub-categories associated with the first and second financial transaction categories are defined and if based on analysis of a selected uncategorized financial transaction a match is found between the selected uncategorized financial transaction and a financial transaction sub-category, the user is automatically presented the matched first financial transaction sub-category as a categorization option.

In one embodiment, the uncategorized financial transaction display includes an estimated tax ramifications display region within the uncategorized financial transaction display. In accordance with one embodiment, the estimated tax ramifications display region includes tax ramifications data indicating the tax ramifications associated with one or more financial transactions designated as business financial transactions.

Consequently, using the embodiments discussed herein, users of financial management systems are provided very basic analysis, interaction, and displays showing how the user and/or business is spending money and allowing the user to easily categorize financial transactions with minimal data entry. In addition, using the embodiments discussed herein, simple data reports and actions are provided that are not overly complicated and are presented to the user in a dynamic, engaging, and interactive display that provides opportunity for simple user interaction with the data and/or user modification.

Therefore, the embodiments discussed herein represent a technical solution to the long standing problem in the technical fields of financial management, data display, and user experience discussed above. As a result, users of the embodiments discussed herein are less likely to simply stop using the financial management system because, as noted, the process actively engages the user while not requiring the user to devote significant time and energy to providing and/or obtaining information that is meaningful to the user.

In addition, users of the embodiments discussed herein can modify, or otherwise enter data associated with specific financial transactions, such as categorization data, through a single screen and largely without the need to enter data through a keyboard, or other input device.

In addition, users of the embodiments discussed herein are far less likely to lose track of which financial transactions to select and/or what categories to apply.

Finally, users of the embodiments discussed are provided displays that are both relevant and intuitive and actively engage the users in the process of analyzing and categorizing their financial transactions. Therefore users are encouraged to become active participants in understanding their financial transactions and the tax or other ramifications of those financial transactions.

As noted above, the embodiments discussed herein provide a solution to the long standing problem of presenting users their financial information in an efficient, relevant, intuitive, interactive, and dynamic way and providing for easy and intuitive categorization of financial transactions. Consequently, both users and providers of financial management systems are benefitted by the embodiments discussed herein.

### BRIEF DESCRIPTION OF THE DRAWINGS

FIG. 1 is a block diagram of an architecture for providing a method and system for providing an intuitive and interactive categorization display in accordance with one embodiment;

FIG. 2 is a flow chart representing one example of a process for providing an intuitive and interactive financial transaction categorization display in accordance with one embodiment;

FIGS. 3A, 3B, 3C, 3D, 3E and 3F show an illustrative example of a process and associated display screens for providing an intuitive and interactive financial transaction categorization display in accordance with one embodiment; and

FIGS. 4A, 4B, 4C, 4D and 4E show an illustrative example of a process and associated display screens for providing an intuitive and interactive travel categorization display in accordance with one embodiment.

Common reference numerals are used throughout the FIGs. and the detailed description to indicate like elements. One skilled in the art will readily recognize that the above FIGs. are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs., which depict one or more exemplary embodiments. Embodiments may be implemented in many different forms and should not be construed as limited to the embodiments set forth herein, shown in the FIGs., and/or described below. Rather, these exemplary embodiments are provided to allow a complete disclosure that conveys the principles of the invention, as set forth in the claims, to those of skill in the art.

Herein, a financial management system can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers financial data, including financial transactional data, from one or more sources and/or has the capability to analyze and categorize at least part of the financial data.

As used herein, the term financial management system includes, but is not limited to the following: computing system implemented, and/or online, and/or web-based, personal and/or business financial management systems, services, packages, programs, modules, or applications; computing system implemented, and/or online, and/or web-based, personal and/or business tax preparation systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

Specific examples of financial management systems include, but are not limited to the following: QuickBooks™, available from Intuit, Inc. of Mountain View, Calif.; QuickBooks On-line™, available from Intuit, Inc. of Mountain View, Calif.; QuickBooks Self Employed available from Intuit, Inc. of Mountain View, Calif.; Mint™, available from Intuit, Inc. of Mountain View, Calif.; Mint On-Line™, available from Intuit, Inc. of Mountain View, Calif.; and/or various other financial management systems discussed herein, and/or known to those of skill in the art at the time of filing, and/or as developed after the time of filing.

As used herein, the terms “computing system,” “computing device,” and “computing entity,” include, but are not limited to, the following: a server computing system; a workstation; a desktop computing system; a mobile computing system, including, but not limited to, smart-phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to, the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the terms “mobile computing system” and “mobile device” are used interchangeably and include, but are not limited to the following: a smart-phone; a cellular phone; a digital wireless telephone; a tablet computing system; a notebook computing system; any portable computing system; a two-way pager; a Personal Digital Assistant (PDA); a media player; an Internet appliance; devices worn or carried by a user; or any other movable/mobile device and/or computing system that includes components that can execute all, or part, of any one of the processes and/or operations as described herein.

Herein, the term “production environment” includes the various components, or assets, used to deploy, implement, access, and use, a given application as that application is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user experience” includes not only the data entry process, but also other user experience features provided or displayed to the user such as, but not limited to the following: interfaces; images; backgrounds; avatars; highlighting mechanisms; icons; and any other features that individually, or in combination, create a user experience, as discussed herein, and/or as known in the art at the time of filing, and/or as developed after the time of filing.

Herein, the term “party,” “user,” “user consumer,” and “customer” are used interchangeably to denote any party and/or entity that interfaces with, and/or to whom information is provided by, the method and system for providing an intuitive and interactive financial transaction categorization display described herein, and/or a person and/or entity that interfaces with, and/or to whom information is provided by, the method and system for providing an intuitive and interactive financial transaction categorization display described herein, and/or a legal guardian of person and/or entity that interfaces with, and/or to whom information is provided by, the method and system for providing an intuitive and interactive financial transaction categorization display described herein, and/or an authorized agent of any party and/or person and/or entity that interfaces with, and/or to whom information is provided by, the method and system for providing an intuitive and interactive financial transaction categorization display described herein. For instance, in various embodiments, a user can be, but is not limited to, a person, a commercial entity, an application, a service, and/or a computing system.

### Method and System

In one embodiment, a method and system for providing an intuitive and interactive financial transaction categorization display includes defining two or more financial transaction categories to be applied to, or otherwise associated with, one or more financial transactions represented in financial transaction data.

In various embodiments, the financial transaction categories represent financial transaction categories used to categorize and process various financial transactions associated with the user. In various embodiments, the financial transaction categories are defined by the provider of the method and system for providing an intuitive and interactive financial transaction categorization display. In other embodiments, the financial transaction categories are defined by one or more financial management systems such as, but not limited to, any of the financial management systems as discussed herein, and/or as known in the art at the time of filing, and/or as developed after the time of filing.

Herein, a financial management system can be, but is not limited to, any data management system that gathers financial data, including financial transactional data, from one or more sources, such as financial accounts and financial institutions, and/or has the capability to analyze and categorize at least part of the financial data.

As discussed above, current financial management systems are typically software applications and/or web-based services, which, along with a parent computing system, server system, or device, help individuals/users manage their finances by providing a centralized interface with banks, credit card companies, and various other financial and asset management institutions and/or accounts, for identifying, processing, storing, and categorizing user financial transactions. Currently, financial management systems typically obtain financial transaction data, such as payee identification, payment amount, date of the transaction, time of transaction, etc., via communication with banks, credit card providers, or other financial institutions, using data entry, and/or links to databases, and/or screen scraping technology, and/or electronic data transfer systems, such as the Open Financial Exchange (OFX) specification, and/or various other systems for obtaining and transferring financial transaction data.

Using some financial management systems, the financial transaction data, payee identification, payment amount, date of the transaction, various descriptions, tags and/or labels, and/or other identifying data is used by the financial management system to identify, categorize, and/or tag individual financial transactions as a particular type of income or expense, to generate various financial reports, to determine a user's tax liability, and to create an overview of the user's financial situation based on input from multiple, and preferably all, available sources of financial information/data regarding a user.

In some embodiments, the financial transaction categories are defined by outside agencies such as, but not limited to, the Internal Revenue Service (IRS) or other state and local tax agencies.

In one embodiment, the financial transaction categories are broad financial transaction categories that include, or encompass, one or more of financial transaction sub-categories as discussed below. In one embodiment, the financial transaction categories are defined in pairs of financial transaction categories that are representative of a broad categorization of various subsets of financial transaction categories.

For instance, in one specific example, the pair of financial transaction categories include “personal” and “business” financial transaction categories where the “personal” financial transaction category is applied to personal related expenses as opposed to “business” related expenses that have tax ramifications.

As noted above, one long standing problem associated with traditional financial management system displays is the inability to present users their financial information in an efficient, relevant, intuitive, interactive, and dynamic way that is of practical use. However, in the disclosed embodiments, by dividing the user's spending transactions between relatively few, in one embodiment only two, financial transaction categories, the user is provided a straightforward display including, in one specific illustrative example, only personal and business financial transaction categories.

In another specific example, the pair of financial transaction categories include “wants” financial transaction category representing discretionary spending financial transactions and a “needs” financial transaction category representing non-discretionary financial transactions. In this specific illustrative example, the financial transaction categories are used to distinguish between financial transactions, and associated financial transaction categories, over which the user has control, i.e., that are associated with spending that is not required, but rather represents desired spending on a “wanted” item or service, as opposed to financial transactions, and associated financial transaction categories, over which the user has no control, i.e., that are associated with spending that is required and is not optional, such as utilities, rent, mortgage, etc.

Another example of pairs of financial transaction categories include, but are not limited to, a “discretionary” and “non-discretionary” financial transaction category pair.

Other examples of pairs of financial transaction categories include any financial transaction categories as discussed herein, and/or as known in the art at the time of filing, and/or as developed after the time of filing.

In one embodiment, once at least two financial transaction categories are defined, financial transaction category data representing the defined financial transaction categories is generated.

In one embodiment, once the financial transaction categories are defined and financial transaction category data is generated, financial transaction data is obtained from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing.

In one embodiment, the financial transaction data is financial transaction data from a defined relevant period of time such as, a day, a week, a month, quarter, a year, etc. In various embodiments the relevant period of time is defined by the user, and/or provider, of the method and system for providing an intuitive and interactive financial transaction categorization display.

In one embodiment, once the financial transaction data is obtained, the financial transaction data is subjected to an initial processing whereby the financial transaction data is analyzed with rules data representing one or more automated initial categorization rules.

In various embodiments, the one or more automated initial categorization rules represented by the rules data is generated by/obtained from one or more of the provider of the method and system for providing an intuitive and interactive financial transaction categorization display, the user, and/or one or more financial management systems. In one embodiment, the one or more automated initial categorization rules represented by the rules data is generated by, and/or updated, based on historical categorizations of financial transactions by the user so that the one or more automated initial categorization rules are continuously updated based on actions taken by the user and customized to the user.

In one embodiment, as a result of the financial transaction data being initially processed in accordance with rules data representing one or more automated categorization rules, some of the financial transactions represented by part of the financial transaction data are categorized automatically as the financial transaction data is received. Consequently, as a result of the financial transaction data being initially processed in accordance with rules data, a categorized portion of the financial transaction data is transformed into initially categorized financial transaction data representing financial transactions categorized according to the rules data as being in either the first or second financial transaction categories. Likewise, an uncategorized portion of the financial transaction data representing financial transactions that are not categorized according to the rules data as being in either the first or second financial transaction categories is also generated/defined.

In accordance with one embodiment, uncategorized financial transaction display data for generating an uncategorized financial transaction display is generated.

In one embodiment, the intuitive and interactive financial transaction categorization display generated by the uncategorized financial transaction display data includes an uncategorized financial transaction listing region including a listing of the uncategorized financial transactions represented by the uncategorized portion of the financial transaction data. Consequently, in accordance with one embodiment, the uncategorized financial transaction display data includes uncategorized financial transaction listing data for generating a listing of the uncategorized financial transactions represented by the uncategorized portion of the financial transaction data in the uncategorized financial transactions listing region of the uncategorized financial transaction display.

In one embodiment, the uncategorized financial transaction listing region of the intuitive and interactive financial transaction categorization display includes an uncategorized financial transaction listing displaying the individual uncategorized financial transactions not yet mapped to either the first or second financial transaction categories. In one embodiment, the uncategorized financial transaction listing region is positioned approximately halfway between the first and second uncategorized financial transaction display regions discussed below.

In accordance with one embodiment, the uncategorized financial transaction display includes at least two uncategorized financial transaction display regions, or directions: a first uncategorized financial transaction display region/direction and a second uncategorized financial transaction display region/direction. Consequently, in one embodiment, the uncategorized financial transaction display data includes financial transaction categorization display regions data for defining the at least two uncategorized financial transaction display regions/directions.

In accordance with one embodiment, the first uncategorized financial transaction display region is associated with the first financial transaction category such that when a given uncategorized financial transaction is selected and then a sweeping motion is made by the user towards the first uncategorized financial transaction display region/direction, the given uncategorized financial transaction is transformed into a first financial transaction category financial transaction. In accordance with one embodiment, the second uncategorized financial transaction display region is associated with the second financial transaction category such that when a given uncategorized financial transaction is selected and then a sweeping motion is made towards the second uncategorized financial transaction display region/direction, the given uncategorized financial transaction is transformed into a second financial transaction category financial transaction.

In various embodiments, the first and second uncategorized financial transaction display regions/directions are visually distinguishable from each other and represented as physically removed from one another. For instance, as a specific illustrative example, in one embodiment, the first display region of the uncategorized financial transaction display is associated with a first color and is displayed in a first display region on a first side of the uncategorized financial transaction display, while the second display region of the uncategorized financial transaction display is of a second color and is displayed in a second display region on a second side of the uncategorized financial transaction display.

As another specific illustrative example, in one embodiment, the first display region of the uncategorized financial transaction display is associated with a first icon graphic of a first color and is displayed in a first display region on a first side of the uncategorized financial transaction display, while the second display region of the uncategorized financial transaction display is associated with a second icon graphic of a second color and is displayed in a second display region on a second side of the uncategorized financial transaction display.

As another specific illustrative example, in one embodiment, the first display region of the uncategorized financial transaction display is associated with a first animated graphic of a first color and is displayed in a first display region on a first side of the uncategorized financial transaction display, while the second display region of the uncategorized financial transaction display is associated with a second animated graphic of a second color and is displayed in a second display region on a second side of the uncategorized financial transaction display.

As another specific illustrative example, in one embodiment, the first display region of the uncategorized financial transaction display is associated with a first shaped graphic of a first color and is displayed in a first display region on a first side of the uncategorized financial transaction display, while the second display region of the uncategorized financial transaction display is associated with a second shaped graphic of a second color and is displayed in a second display region on a second side of the uncategorized financial transaction display.

As another specific illustrative example, in one embodiment, the first display region of the uncategorized financial transaction display is associated with a first symbol graphic of a first color and is displayed in a first display region on a first side of the uncategorized financial transaction display, while the second display region of the uncategorized financial transaction display is associated with a second symbol graphic of a second color and is displayed in a second display region on a second side of the uncategorized financial transaction display.

As another specific illustrative example, in one embodiment, the first display region of the uncategorized financial transaction display is associated with a first alpha-numeric graphic of a first color and is displayed in a first display region on a first side of the uncategorized financial transaction display, while the second display region of the uncategorized financial transaction display is associated with a second alpha-numeric graphic of a second color and is displayed in a second display region on a second side of the uncategorized financial transaction display.

As another specific illustrative example, in one embodiment, the first display region of the uncategorized financial transaction display is associated with a first avatar graphic of a first color and is displayed in a first display region on a first side of the uncategorized financial transaction display, while the second display region of the uncategorized financial transaction display is associated with a second avatar graphic of a second color and is displayed in a second display region on a second side of the uncategorized financial transaction display.

In various other embodiments, the first display region of the uncategorized financial transaction display is associated with any graphic of any color and is displayed in a first display region in any region of the intuitive and interactive financial transaction categorization display, while the second display region of the uncategorized financial transaction display is associated with any graphic of any color and is displayed in a second display region in any different region of the intuitive and interactive financial transaction categorization display.

In accordance with one embodiment, the uncategorized financial transaction display data is used to generate an uncategorized financial transaction display including an uncategorized financial transactions listing region, a first uncategorized financial transaction display region, and a second uncategorized financial transaction display region. In one embodiment, once the intuitive and interactive financial transaction categorization display is generated, the intuitive and interactive financial transaction categorization display is provided to the user on a display screen of a user computing system owed, accessible by, or otherwise associated with, the user.

In various embodiments, the user computing system is any computing system as discussed herein, and/or as known in the art at the time of filing, and/or as developed after the time of filing.

In various embodiments, the display screen of the user computing system is a touch screen, or other interactive display screen capable of receiving user input via touch, stylus, or other user input device or mechanism, as discussed herein, and/or as known in the art at the time of filing, and/or as developed after the time of filing.

In one embodiment, the user is provided the opportunity to dynamically and intuitively categorize each of the uncategorized financial transactions in either the first financial transaction category or the second financial transaction category. In accordance with one embodiment, the user is provided the capability to categorize each of the uncategorized financial transactions represented by the uncategorized financial transaction listing data of the uncategorized financial transaction display data by selecting an uncategorized financial transaction listed in the uncategorized financial transaction display and making a sweeping motion to, or in the direction of, either the first or second region of the uncategorized financial transaction display.

In accordance with one embodiment, a selected uncategorized financial transaction swept to the first region of the uncategorized financial transaction display is automatically categorized as a member of first financial transaction category by transforming the portion of the uncategorized financial transaction listing data representing the uncategorized financial transaction to first financial transaction category categorized financial transaction listing data representing the formerly uncategorized financial transaction as a first financial transaction category financial transaction.

Likewise, in accordance with one embodiment, a selected uncategorized financial transaction swept to the second region of the uncategorized financial transaction display is automatically categorized as a member of second financial transaction category by transforming the portion of the uncategorized financial transaction listing data representing the uncategorized financial transaction to second financial transaction category categorized financial transaction listing data representing the formerly uncategorized financial transaction as a second financial transaction category financial transaction.

Consequently, using the method and system for providing an intuitive and interactive financial transaction categorization display, first financial transaction category spending, such as personal/business spending, and second financial transaction category spending, such as business/personal spending, can be determined and displayed in an engaging and “game-like” manner via a simple user interaction motion, such as, but not limited to, a single sweeping action of the user's finger towards the first spending display region of the disclosed interactive uncategorized financial transaction display or the second spending display region of the disclosed interactive uncategorized financial transaction display.

In one embodiment, one or more financial transaction sub-categories associated with the first and second financial transaction categories are defined and first and second financial transaction category sub-categories data is generated.

In accordance with one embodiment, elements of first and second financial transaction category categorized financial transaction listing data are mapped to the first and second financial transaction category sub-categories data such that, in accordance with one embodiment, once the user categorizes a financial transaction as a first financial transaction by selecting an uncategorized financial transaction listed in the uncategorized financial transaction display and making a sweeping motion to the first uncategorized financial transaction display region of the uncategorized financial transaction display, the portion of the financial transaction data representing the first financial transaction category categorized financial transaction is processed to identify a match with a portion of the first financial transaction sub-category data representing one or more of the one or more first financial transaction sub-categories. In accordance with one embodiment, if a match is identified between the portion of the financial transaction data representing the first financial transaction category categorized financial transaction and a portion of the first financial transaction sub-category data representing one or more of the one or more first financial transaction sub-categories, the user is automatically presented the matched first financial transaction sub-category as a categorization option.

Likewise, in accordance with one embodiment, once the user categorizes a financial transaction as a second financial transaction by selecting an uncategorized financial transaction listed in the uncategorized financial transaction display and making a sweeping motion to the second uncategorized financial transaction display region of the uncategorized financial transaction display, the portion of the financial transaction data representing the second financial transaction category categorized financial transaction is processed to identify a match with a portion of the second financial transaction sub-category data representing one or more of the one or more second financial transaction sub-categories. In accordance with one embodiment, if a match is identified between the portion of the financial transaction data representing the second financial transaction category categorized financial transaction and a portion of the second financial transaction sub-category data representing one or more of the one or more second financial transaction sub-categories, the user is automatically presented the matched second financial transaction sub-category as a categorization option.

Using the method and system for providing an intuitive and interactive financial transaction categorization display discussed above, the user is provided a visual representation of the user's uncategorized financial transactions and is provided the capability to categorize the uncategorized financial transactions by simply selecting the uncategorized financial transactions and making a swiping motion towards the relevant portion of the interactive uncategorized financial transaction display.

Consequently, using the method and system for providing an intuitive and interactive financial transaction categorization display discussed above provides a solution to the long standing problem of presenting users their financial information in an efficient, intuitive, interactive, and dynamic way that is of practical use. Therefore, the method and system for providing an intuitive and interactive financial transaction categorization display discussed above significantly improves the technical fields of data entry/selection and user experience. Specifically, a user's experience is improved and simplified using embodiments of the present disclosure so that the user experience is less burdensome and more “game-like” in its interactions and user experience. Therefore, the user is more motivated to actively participate in the spending analysis and, by simplifying and speeding up the process of categorization, the user is allowed to dedicate more of his or her time to other activities. Therefore, implementations of embodiments of the present disclosure represent a significant improvement to the field of user experience and, in particular, efficient use of human and non-human resources.

In addition, by eliminating the necessity of performing unnecessary analysis and displaying detailed, and often undesired, reports and data, there is less data entry, less processing of data, and fewer errors in entered data. Consequently, using the method and system for providing an intuitive and interactive financial transaction categorization display discussed above, fewer processor cycles are utilized, memory utilization is reduced, and less communications bandwidth is utilized to relay data to and from backend systems. As a result, computing systems, and particularly mobile computing systems, are transformed into faster, more efficient, and more effective computing systems by implementing the method and system for providing an intuitive and interactive financial transaction categorization display discussed above.

The various embodiments of the method and system for providing an intuitive and interactive financial transaction categorization display discussed above, and their associated benefits, also improve the technical field of financial management by providing users with a relevant and simple spending and financial display while requiring minimal user input, and the ability to provide that user input in an efficient manner. In addition, embodiments of the method and system for providing an intuitive and interactive financial transaction categorization display discussed above allow the financial management system to offer a more relevant analysis of a user's financial situation. Further, the increased relevancy of the data provided using the method and system for providing an intuitive and interactive financial transaction categorization display discussed above increase the chances that a user will continue using the financial management system.

As a result, using implementations of the method and system for providing an intuitive and interactive financial transaction categorization display discussed above, the fields of financial management, financial transaction data processing, data entry, data display, data processing, and user experience are significantly improved.

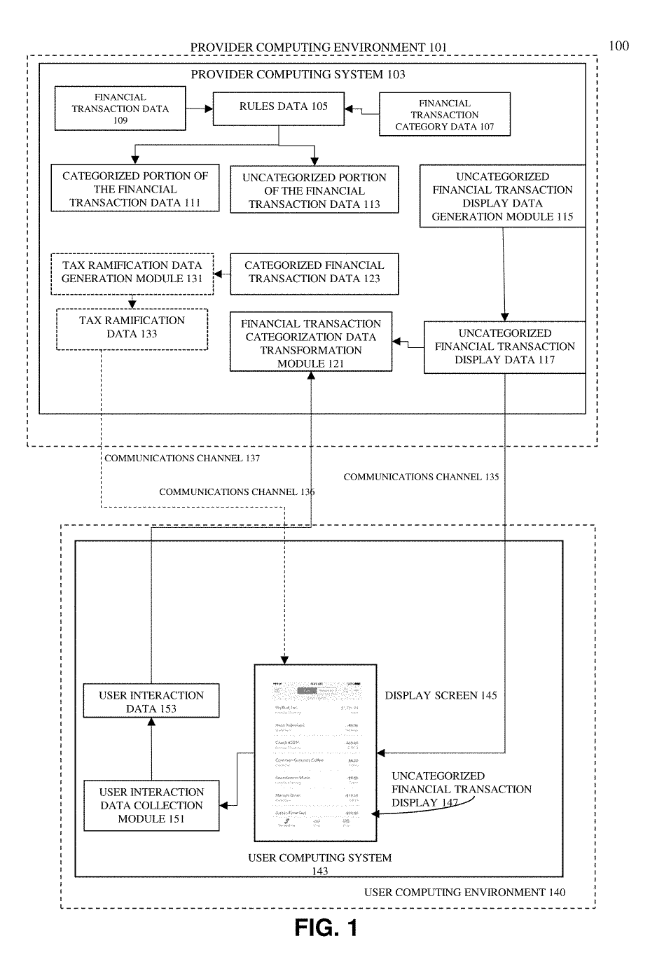

FIG. 1 is a block diagram of a hardware and production environment 100 for, in one embodiment, implementing a method and system for providing an intuitive and interactive financial transaction categorization display. As seen in FIG. 1, provider computing system 103 is shown as implemented in provider computing environment 101 and user computing system 143 is shown as implemented in user computing environment 140. As seen in FIG. 1, provider computing system 103 and provider computing environment 101 are communicatively coupled to user computing environment 140 and user computing system 143 via communications channels 135, 136, and 137.

As seen in FIG. 1, in one embodiment, provider computing system 103 includes financial transaction category data 107 defining two or more financial transaction categories to be applied to, or otherwise associated with, one or more financial transactions represented in financial transaction data 109.

In one embodiment, financial transaction data 109 is obtained from one or more financial management systems and/or other financial transaction data sources (not shown), such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing

As seen in FIG. 1, in one embodiment, provider computing system 103 includes rules data 105 representing one or more automated initial categorization rules.

In various embodiments, the one or more automated initial categorization rules represented by rules data 105 are generated by/obtained from one or more of the provider of the method and system for providing an intuitive and interactive financial transaction categorization display, the user, and/or one or more financial management systems. In one embodiment, the one or more automated initial categorization rules represented by rules data 105 are generated by, and/or updated, based on historical categorizations of financial transactions by the user and represented by user interaction data 153 so that the one or more automated initial categorization rules are continuously updated based on actions taken by the user and customized to the user.

In one embodiment, as a result of financial transaction data 109 being initially processed in accordance with rules data 105 representing one or more automated categorization rules, some of the financial transactions represented by part of the financial transaction data 109 are categorized automatically as financial transaction data 109 is received. Consequently, as a result of financial transaction data 109 being initially processed in accordance with rules data 105 a portion of financial transaction data 109 is transformed into initially categorized portion of the financial transaction data 111 representing financial transactions categorized according to the rules data as being in either the first or second financial transaction categories. Likewise, an uncategorized portion of the financial transaction data 113 of financial transaction data 109 representing financial transactions that are not categorized according to rules data 105 as being in either the first or second financial transaction categories is also generated/defined.

As seen in FIG. 1, in one embodiment, provider computing system 103 includes uncategorized financial transaction display data generation module 115 for generating uncategorized financial transaction display data 117.

As seen in FIG. 1, in one embodiment, uncategorized financial transaction display data 117 is used to generate uncategorized financial transaction display 147 on display screen 145 of user computing system 143.

As discussed above, uncategorized financial transaction display 147 includes an uncategorized financial transaction listing region including a listing of the uncategorized financial transactions represented by the uncategorized portion of the financial transaction data and at least two uncategorized financial transaction display regions, or directions (not shown): a first uncategorized financial transaction display region/direction and a second uncategorized financial transaction display region/direction. In accordance with one embodiment, the first uncategorized financial transaction display region is associated with the first financial transaction category such that when a given uncategorized financial transaction is selected and then a sweeping motion is made by the user towards the first uncategorized financial transaction display region/direction, user interaction data 153 is collected by user interaction data collection module 151 and the given uncategorized financial transaction is transformed by financial transaction categorization data transformation module 121 into a first financial transaction category financial transaction. Then, in one embodiment, categorized financial transaction data 123 is updated accordingly.

In accordance with one embodiment, the second uncategorized financial transaction display region is associated with the second financial transaction category such that when a given uncategorized financial transaction is selected and then a sweeping motion is made towards the second uncategorized financial transaction display region/direction, user interaction data 153 is collected by user interaction data collection module 151 and the given uncategorized financial transaction is transformed by financial transaction categorization data transformation module 121 into a second financial transaction category financial transaction. Then, in one embodiment, categorized financial transaction data 123 is updated accordingly

As seen in FIG. 1, in one embodiment, provider computing system 103 includes tax ramification data generation module 131 and tax ramification data 133.

As discussed below, in some embodiments, tax ramification data generation module 131 is used to generate tax ramification data 133 and tax ramification data 133 is used for generating an estimated tax ramifications display region (not shown) within uncategorized financial transaction display 147.

In one embodiment, a method and system for providing an intuitive and interactive financial transaction categorization display includes defining personal and business financial transaction categories to be applied to, or otherwise associated with, one or more financial transactions represented in financial transaction data.

In various embodiments, the personal and business financial transaction categories represent financial transaction categories used to categorize and process various financial transactions associated with the user.

As noted above, one long standing problem associated with traditional financial management system displays is the inability to present users their financial information in an efficient, relevant, intuitive, interactive, and dynamic way that is of practical use. However, in the disclosed embodiments, by dividing the user's spending transactions between relatively few, in one embodiment only two, financial transaction categories, the user is provided a straightforward display including, in one specific illustrative example, only personal and business financial transaction categories.

In one embodiment, once personal and business financial transaction categories are defined, financial transaction category data representing the defined financial transaction categories is generated.

In one embodiment, once the personal and business financial transaction categories are defined and financial transaction category data is generated, financial transaction data is obtained from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing.

In one embodiment, the financial transaction data is financial transaction data from a defined relevant period of time such as, a day, a week, a month, quarter, a year, etc. In various embodiments the relevant period of time is defined by the user, and/or provider, of the method and system for providing an intuitive and interactive financial transaction categorization display.

In one embodiment, once the financial transaction data is obtained, the financial transaction data is subjected to an initial processing whereby the financial transaction data is analyzed with rules data representing one or more automated initial categorization rules.

In various embodiments, the one or more automated initial categorization rules represented by the rules data is generated by/obtained from one or more of the provider of the method and system for providing an intuitive and interactive financial transaction categorization display, the user, and/or one or more financial management systems. In one embodiment, the one or more automated initial categorization rules represented by the rules data is generated by, and/or updated, based on historical categorizations of financial transactions by the user so that the one or more automated initial categorization rules are continuously updated based on actions taken by the user and customized to the user.

In one embodiment, as a result of the financial transaction data being initially processed in accordance with rules data representing one or more automated categorization rules, some of the financial transactions represented by part of the financial transaction data are categorized automatically as the financial transaction data is received. Consequently, as a result of the financial transaction data being initially processed in accordance with rules data, a categorized portion of the financial transaction data is transformed into initially categorized financial transaction data representing financial transactions categorized according to the rules data as being in either the personal or business financial transaction categories. Likewise, an uncategorized portion of the financial transaction data representing financial transactions that are not categorized according to the rules data as being in either the personal or business financial transaction categories is also generated/defined.

In accordance with one embodiment, uncategorized financial transaction display data for generating an uncategorized financial transaction display is generated.

In one embodiment, the intuitive and interactive financial transaction categorization display generated by the uncategorized financial transaction display data includes an uncategorized financial transaction listing region including a listing of the uncategorized financial transactions represented by the uncategorized portion of the financial transaction data. Consequently, in accordance with one embodiment, the uncategorized financial transaction display data includes uncategorized financial transaction listing data for generating a listing of the uncategorized financial transactions represented by the uncategorized portion of the financial transaction data in the uncategorized financial transactions listing region of the uncategorized financial transaction display.

In one embodiment, the uncategorized financial transaction listing region of the intuitive and interactive financial transaction categorization display includes an uncategorized financial transaction listing displaying the individual uncategorized financial transactions not yet mapped to either the personal or business financial transaction categories. In one embodiment, the uncategorized financial transaction listing region is positioned approximately halfway between the personal and business uncategorized financial transaction display regions discussed below.

In accordance with one embodiment, the uncategorized financial transaction display includes at least two uncategorized financial transaction display regions, or directions: a personal uncategorized financial transaction display region/direction and a business uncategorized financial transaction display region/direction. Consequently, in one embodiment, the uncategorized financial transaction display data includes financial transaction categorization display regions data for defining the personal and business uncategorized financial transaction display regions/directions.

In accordance with one embodiment, the personal uncategorized financial transaction display region is associated with the personal financial transaction category such that when a given uncategorized financial transaction is selected and then a sweeping motion is made by the user towards the personal uncategorized financial transaction display region/direction, the given uncategorized financial transaction is transformed into a personal financial transaction category financial transaction. In accordance with one embodiment, the business uncategorized financial transaction display region is associated with the business financial transaction category such that when a given uncategorized financial transaction is selected and then a sweeping motion is made towards the business uncategorized financial transaction display region/direction, the given uncategorized financial transaction is transformed into a business financial transaction category financial transaction.

In various embodiments, the personal and business uncategorized financial transaction display regions/directions are visually distinguishable from each other and represented as physically removed from one another. For instance, as a specific illustrative example, in one embodiment, the personal display region of the uncategorized financial transaction display is associated with a first color and is displayed in a personal display region on a first side of the uncategorized financial transaction display, while the business display region of the uncategorized financial transaction display is of a second color and is displayed in a business display region on a second side of the uncategorized financial transaction display.

As another specific illustrative example, in one embodiment, the personal display region of the uncategorized financial transaction display is associated with a first icon graphic of a first color and is displayed in a personal display region on a first side of the uncategorized financial transaction display, while the business display region of the uncategorized financial transaction display is associated with a second icon graphic of a second color and is displayed in a business display region on a second side of the uncategorized financial transaction display.

As another specific illustrative example, in one embodiment, the personal display region of the uncategorized financial transaction display is associated with a first animated graphic of a first color and is displayed in a personal display region on a first side of the uncategorized financial transaction display, while the business display region of the uncategorized financial transaction display is associated with a second animated graphic of a second color and is displayed in a business display region on a second side of the uncategorized financial transaction display.

As another specific illustrative example, in one embodiment, the personal display region of the uncategorized financial transaction display is associated with a first shaped graphic of a first color and is displayed in a personal display region on a first side of the uncategorized financial transaction display, while the business display region of the uncategorized financial transaction display is associated with a second shaped graphic of a second color and is displayed in a business display region on a second side of the uncategorized financial transaction display.

As another specific illustrative example, in one embodiment, the personal display region of the uncategorized financial transaction display is associated with a first symbol graphic of a first color and is displayed in a personal display region on a first side of the uncategorized financial transaction display, while the business display region of the uncategorized financial transaction display is associated with a second symbol graphic of a second color and is displayed in a business display region on a second side of the uncategorized financial transaction display.

As another specific illustrative example, in one embodiment, the personal display region of the uncategorized financial transaction display is associated with a first alpha-numeric graphic of a first color and is displayed in a personal display region on a first side of the uncategorized financial transaction display, while the business display region of the uncategorized financial transaction display is associated with a second alpha-numeric graphic of a second color and is displayed in a business display region on a second side of the uncategorized financial transaction display.

As another specific illustrative example, in one embodiment, the personal display region of the uncategorized financial transaction display is associated with a first avatar graphic of a first color and is displayed in a personal display region on a first side of the uncategorized financial transaction display, while the business display region of the uncategorized financial transaction display is associated with a second avatar graphic of a second color and is displayed in a business display region on a second side of the uncategorized financial transaction display.

In various other embodiments, the personal display region of the uncategorized financial transaction display is associated with any graphic of any color and is displayed in a personal display region in any region of the intuitive and interactive financial transaction categorization display, while the business display region of the uncategorized financial transaction display is associated with any graphic of any color and is displayed in a business display region in any different region of the intuitive and interactive financial transaction categorization display.

In accordance with one embodiment, the uncategorized financial transaction display data is used to generate an uncategorized financial transaction display including an uncategorized financial transactions listing region, a personal uncategorized financial transaction display region, and a business uncategorized financial transaction display region. In one embodiment, once the intuitive and interactive financial transaction categorization display is generated, the intuitive and interactive financial transaction categorization display is provided to the user on a display screen of a user computing system owed, accessible by, or otherwise associated with, the user.

In various embodiments, the user computing system is any computing system as discussed herein, and/or as known in the art at the time of filing, and/or as developed after the time of filing.

In various embodiments, the display screen of the user computing system is a touch screen, or other interactive display screen capable of receiving user input via touch, stylus, or other user input device or mechanism, as discussed herein, and/or as known in the art at the time of filing, and/or as developed after the time of filing.

In one embodiment, the user is provided the opportunity to dynamically and intuitively categorize each of the uncategorized financial transactions in either the personal financial transaction category or the business financial transaction category. In accordance with one embodiment, the user is provided the capability to categorize each of the uncategorized financial transactions represented by the uncategorized financial transaction listing data of the uncategorized financial transaction display data by selecting an uncategorized financial transaction listed in the uncategorized financial transaction display and making a sweeping motion to, or in the direction of, either the first or second region of the uncategorized financial transaction display.

In accordance with one embodiment, a selected uncategorized financial transaction swept to the first region of the uncategorized financial transaction display is automatically categorized as a member of personal financial transaction category by transforming the portion of the uncategorized financial transaction listing data representing the uncategorized financial transaction to personal financial transaction category categorized financial transaction listing data representing the formerly uncategorized financial transaction as a personal financial transaction category financial transaction.

Likewise, in accordance with one embodiment, a selected uncategorized financial transaction swept to the second region of the uncategorized financial transaction display is automatically categorized as a member of business financial transaction category by transforming the portion of the uncategorized financial transaction listing data representing the uncategorized financial transaction to business financial transaction category categorized financial transaction listing data representing the formerly uncategorized financial transaction as a business financial transaction category financial transaction.

Consequently, using the method and system for providing an intuitive and interactive financial transaction categorization display, personal financial transaction category spending and business financial transaction category spending can be designated, determined, and displayed in an engaging and “game-like” manner via a simple user interaction motion, such as, but not limited to, a single sweeping action of the user's finger towards the first spending display region of the disclosed interactive uncategorized financial transaction display or the second spending display region of the disclosed interactive uncategorized financial transaction display.

In one embodiment, one or more financial transaction sub-categories associated with the personal and business financial transaction categories are defined and personal and business financial transaction category sub-categories data is generated.

In accordance with one embodiment, elements of personal and business financial transaction category categorized financial transaction listing data are mapped to the personal and business financial transaction category sub-categories data such that, in accordance with one embodiment, once the user categorizes a financial transaction as a personal financial transaction by selecting an uncategorized financial transaction listed in the uncategorized financial transaction display and making a sweeping motion to the personal uncategorized financial transaction display region of the uncategorized financial transaction display, the portion of the financial transaction data representing the personal financial transaction category categorized financial transaction is processed to identify a match with a portion of the personal financial transaction sub-category data representing one or more of the one or more personal financial transaction sub-categories. In accordance with one embodiment, if a match is identified between the portion of the financial transaction data representing the personal financial transaction category categorized financial transaction and a portion of the personal financial transaction sub-category data representing one or more of the one or more personal financial transaction sub-categories, the user is automatically presented the matched personal financial transaction sub-category as a categorization option.

Likewise, in accordance with one embodiment, once the user categorizes a financial transaction as a business financial transaction by selecting an uncategorized financial transaction listed in the uncategorized financial transaction display and making a sweeping motion to the business uncategorized financial transaction display region of the uncategorized financial transaction display, the portion of the financial transaction data representing the business financial transaction category categorized financial transaction is processed to identify a match with a portion of the business financial transaction sub-category data representing one or more of the one or more business financial transaction sub-categories. In accordance with one embodiment, if a match is identified between the portion of the financial transaction data representing the business financial transaction category categorized financial transaction and a portion of the business financial transaction sub-category data representing one or more of the one or more business financial transaction sub-categories, the user is automatically presented the matched business financial transaction sub-category as a categorization option.

In one embodiment, the uncategorized financial transaction display data includes estimated tax ramifications display region data for generating an estimated tax ramifications display region within the uncategorized financial transaction display. In accordance with one embodiment, the estimated tax ramifications display region includes tax ramifications data indicating the tax ramifications associated with one or more financial transactions designated as business financial transactions. In accordance with one embodiment, once the user categorizes a financial transaction as a business financial transaction by selecting an uncategorized financial transaction listed in the uncategorized financial transaction display and making a sweeping motion to the business uncategorized financial transaction display region of the uncategorized financial transaction display, the portion of the financial transaction data representing the business financial transaction category categorized financial transaction is processed to determine the estimated tax ramifications of the business financial transaction category categorized financial transaction and the estimated tax ramifications data is updated to reflect the estimated tax ramifications associated with the business financial transaction category categorized financial transaction.

Using the method and system for providing an intuitive and interactive financial transaction categorization display discussed above, the user is provided a visual representation of the user's uncategorized financial transactions and is provided the capability to categorize the uncategorized financial transactions by simply selecting the uncategorized financial transactions and making a swiping motion towards the relevant portion of the interactive uncategorized financial transaction display.

Consequently using the method and system for providing an intuitive and interactive financial transaction categorization display discussed above provides a solution to the long standing problem of presenting users their financial information in an efficient, intuitive, interactive, and dynamic way that is of practical use. Therefore, the method and system for providing an intuitive and interactive financial transaction categorization display discussed above significantly improves the technical fields of data entry/selection and user experience. Specifically, a user's experience is improved and simplified using embodiments of the present disclosure so that the user experience is less burdensome and more “game-like” in its interactions and user experience. Therefore, the user is more motivated to actively participate in the spending analysis and, by simplifying and speeding up the process of categorization, the user is allowed to dedicate more of his or her time to other activities. Therefore, implementations of embodiments of the present disclosure represent a significant improvement to the field of user experience and, in particular, efficient use of human and non-human resources.

In addition, by eliminating the necessity of performing unnecessary analysis and displaying detailed, and often undesired, reports and data, there is less data entry, less processing of data, and fewer errors in entered data. Consequently, using the method and system for providing an intuitive and interactive financial transaction categorization display discussed above, fewer processor cycles are utilized, memory utilization is reduced, and less communications bandwidth is utilized to relay data to and from backend systems. As a result, computing systems, and particularly mobile computing systems, are transformed into faster, more efficient, and more effective computing systems by implementing the method and system for providing an intuitive and interactive financial transaction categorization display discussed above.

The various embodiments of the method and system for providing an intuitive and interactive financial transaction categorization display discussed above, and their associated benefits, also improve the technical field of financial management by providing users with a relevant and simple spending and financial display while requiring minimal user input, and the ability to provide that user input in an efficient manner. In addition, embodiments of the method and system for providing an intuitive and interactive financial transaction categorization display discussed above allow the financial management system to offer a more relevant analysis of a user's financial situation. Further, the increased relevancy of the data provided using the method and system for providing an intuitive and interactive financial transaction categorization display discussed above increase the chances that a user will continue using the financial management system.

As a result, using implementations of the method and system for providing an intuitive and interactive financial transaction categorization display discussed above, the fields of financial management, financial transaction data processing, data entry, data display, data processing, and user experience are significantly improved.

In one embodiment, a method and system for providing an intuitive and interactive travel categorization display includes defining personal and business travel categories to be applied to, or otherwise associated with, one or more trips represented in travel data.

In various embodiments, the personal and business travel categories represent travel categories used to categorize and process various trips associated with the user.

As noted above, one long standing problem associated with traditional financial management system displays is the inability to present users their financial information in an efficient, relevant, intuitive, interactive, and dynamic way that is of practical use. However, in the disclosed embodiments, by dividing the user's trips between relatively few, in one embodiment only two, travel categories, the user is provided a straightforward display including, in one specific illustrative example, only personal and business travel categories.

In one embodiment, once personal and business travel categories are defined, travel category data representing the defined travel categories is generated.

In one embodiment, once the personal and business travel categories are defined and travel category data is generated, travel data is obtained from one or more financial management systems and/or other travel data sources, such as any of the financial management systems and/or other travel data sources discussed herein, and/or as known in the art at the time of filing, and/or as developed after the time of filing, and/or by any means as discussed herein, and/or as known in the art at the time of filing, and/or as becomes known after the time of filing.

In one embodiment, the travel data is travel data from a defined relevant period of time such as, a day, a week, a month, quarter, a year, etc. In various embodiments the relevant period of time is defined by the user, and/or provider, of the method and system for providing an intuitive and interactive travel categorization display.

In one embodiment, the travel data is presented as maps of recent trips conducted by the user and recorded using one or more travel trackers implemented on a user computing system.

In one embodiment, once the travel data is obtained, the travel data is subjected to an initial processing whereby the travel data is analyzed with rules data representing one or more automated initial categorization rules.

In various embodiments, the one or more automated initial categorization rules represented by the rules data is generated by/obtained from one or more of the provider of the method and system for providing an intuitive and interactive travel categorization display, the user, and/or one or more financial management systems. In one embodiment, the one or more automated initial categorization rules represented by the rules data is generated by, and/or updated, based on historical categorizations of travel/trips by the user so that the one or more automated initial categorization rules are continuously updated based on actions taken by the user and customized to the user.

In one embodiment, as a result of the travel data being initially processed in accordance with rules data representing one or more automated categorization rules, some of the travel/trips represented by part of the travel data are categorized automatically as the travel data is received. Consequently, as a result of the travel data being initially processed in accordance with rules data, a categorized portion of the travel data is transformed into initially categorized travel data representing travel/trips categorized according to the rules data as being in either the personal or business travel categories. Likewise, an uncategorized portion of the travel data representing travel/trips that are not categorized according to the rules data as being in either the personal or business travel categories is also generated/defined.

In accordance with one embodiment, uncategorized travel display data for generating an uncategorized travel display is generated.

In one embodiment, the intuitive and interactive travel categorization display generated by the uncategorized travel display data includes an uncategorized travel listing region including a listing of the uncategorized travel/trips represented by the uncategorized portion of the travel data. As noted above, in one embodiment, the listing of the uncategorized travel/trips represented by the uncategorized portion of the travel data is presented in the form of maps representing the uncategorized trips. Consequently, in accordance with one embodiment, the uncategorized travel display data includes uncategorized travel listing data for generating a listing of the uncategorized travel/trips represented by the uncategorized portion of the travel data in the uncategorized travel listing region of the uncategorized travel display.

In one embodiment, the uncategorized travel listing region of the intuitive and interactive travel categorization display includes an uncategorized travel listing displaying the individual uncategorized travel/trips not yet mapped to either the personal or business travel categories. In one embodiment, the uncategorized travel listing region is positioned approximately halfway between the personal and business uncategorized travel display regions discussed below.

In accordance with one embodiment, the uncategorized travel display includes at least two uncategorized travel display regions, or directions: a personal uncategorized travel display region/direction and a business uncategorized travel display region/direction. Consequently, in one embodiment, the uncategorized travel display data includes travel categorization display regions data for defining the personal and business uncategorized travel display regions/directions.

In accordance with one embodiment, the personal uncategorized travel display region is associated with the personal travel category such that when a given uncategorized trip, or portion of a given uncategorized trip, is selected and then a sweeping motion is made by the user towards the personal uncategorized travel display region/direction, the given uncategorized trip, or portion of a given uncategorized trip, is transformed into a personal travel category trip. In accordance with one embodiment, the business uncategorized travel display region is associated with the business travel category such that when a given uncategorized trip, or portion of a given uncategorized trip, is selected and then a sweeping motion is made towards the business uncategorized travel display region/direction, the given uncategorized trip, or portion of a given uncategorized trip, is transformed into a business travel category trip.

In various embodiments, the personal and business uncategorized travel display regions/directions are visually distinguishable from each other and represented as physically removed from one another. For instance, as a specific illustrative example, in one embodiment, the personal display region of the uncategorized travel display is associated with a first color and is displayed in a personal display region on a first side of the uncategorized travel display, while the business display region of the uncategorized travel display is of a second color and is displayed in a business display region on a second side of the uncategorized travel display.

As another specific illustrative example, in one embodiment, the personal display region of the uncategorized travel display is associated with a first icon graphic of a first color and is displayed in a personal display region on a first side of the uncategorized travel display, while the business display region of the uncategorized travel display is associated with a second icon graphic of a second color and is displayed in a business display region on a second side of the uncategorized travel display.

As another specific illustrative example, in one embodiment, the personal display region of the uncategorized travel display is associated with a first animated graphic of a first color and is displayed in a personal display region on a first side of the uncategorized travel display, while the business display region of the uncategorized travel display is associated with a second animated graphic of a second color and is displayed in a business display region on a second side of the uncategorized travel display.

As another specific illustrative example, in one embodiment, the personal display region of the uncategorized travel display is associated with a first shaped graphic of a first color and is displayed in a personal display region on a first side of the uncategorized travel display, while the business display region of the uncategorized travel display is associated with a second shaped graphic of a second color and is displayed in a business display region on a second side of the uncategorized travel display.

As another specific illustrative example, in one embodiment, the personal display region of the uncategorized travel display is associated with a first symbol graphic of a first color and is displayed in a personal display region on a first side of the uncategorized travel display, while the business display region of the uncategorized travel display is associated with a second symbol graphic of a second color and is displayed in a business display region on a second side of the uncategorized travel display.

As another specific illustrative example, in one embodiment, the personal display region of the uncategorized travel display is associated with a first alpha-numeric graphic of a first color and is displayed in a personal display region on a first side of the uncategorized travel display, while the business display region of the uncategorized travel display is associated with a second alpha-numeric graphic of a second color and is displayed in a business display region on a second side of the uncategorized travel display.

As another specific illustrative example, in one embodiment, the personal display region of the uncategorized travel display is associated with a first avatar graphic of a first color and is displayed in a personal display region on a first side of the uncategorized travel display, while the business display region of the uncategorized travel display is associated with a second avatar graphic of a second color and is displayed in a business display region on a second side of the uncategorized travel display.

In various other embodiments, the personal display region of the uncategorized travel display is associated with any graphic of any color and is displayed in a personal display region in any region of the intuitive and interactive travel categorization display, while the business display region of the uncategorized travel display is associated with any graphic of any color and is displayed in a business display region in any different region of the intuitive and interactive travel categorization display.

In accordance with one embodiment, the uncategorized travel display data is used to generate an uncategorized travel display including an uncategorized travel listing region, a personal uncategorized travel display region, and a business uncategorized travel display region. In one embodiment, once the intuitive and interactive travel categorization display is generated, the intuitive and interactive travel categorization display is provided to the user on a display screen of a user computing system owed, accessible by, or otherwise associated with, the user.

In various embodiments, the user computing system is any computing system as discussed herein, and/or as known in the art at the time of filing, and/or as developed after the time of filing.

In various embodiments, the display screen of the user computing system is a touch screen, or other interactive display screen capable of receiving user input via touch, stylus, or other user input device or mechanism, as discussed herein, and/or as known in the art at the time of filing, and/or as developed after the time of filing.

In one embodiment, the user is provided the opportunity to dynamically and intuitively categorize each of the uncategorized travel/trips in either the personal travel category or the business travel category. In accordance with one embodiment, the user is provided the capability to categorize each of the uncategorized travel/trips represented by the uncategorized travel listing data of the uncategorized travel display data by selecting an uncategorized trip listed in the uncategorized travel display and making a sweeping motion to, or in the direction of, either the first or second region of the uncategorized travel display.

In accordance with one embodiment, a selected uncategorized trip swept to the personal region of the uncategorized travel display is automatically categorized as a member of personal travel category by transforming the portion of the uncategorized travel listing data representing the uncategorized travel to personal travel category categorized travel listing data representing the formerly uncategorized travel as a personal travel category trip.

Likewise, in accordance with one embodiment, a selected uncategorized travel swept to the business region of the uncategorized travel display is automatically categorized as a member of business travel category by transforming the portion of the uncategorized travel listing data representing the uncategorized travel to business travel category categorized travel listing data representing the formerly uncategorized travel as a business category travel.

Consequently, using the method and system for providing an intuitive and interactive travel categorization display, personal trips/travel and business trips/travel can be designated, determined, and displayed in an engaging and “game-like” manner via a simple user interaction motion, such as, but not limited to, a single sweeping action of the user's finger towards the first uncategorized travel region of the disclosed interactive uncategorized travel display or the second uncategorized travel region spending display region of the disclosed interactive uncategorized travel display.

In one embodiment, one or more travel sub-categories associated with the personal and business travel categories are defined and personal and business travel category sub-categories data is generated.

In accordance with one embodiment, elements of personal and business travel category categorized travel listing data are mapped to the personal and business travel category sub-categories data such that, in accordance with one embodiment, once the user categorizes a trip as personal travel by selecting an uncategorized trip listed in the uncategorized travel display and making a sweeping motion to the personal uncategorized travel display region of the uncategorized travel display, the portion of the travel data representing the personal travel category categorized trip is processed to identify a match with a portion of the personal travel sub-category data representing one or more of the one or more personal travel sub-categories. In accordance with one embodiment, if a match is identified between the portion of the travel data representing the personal travel category categorized trip and a portion of the personal travel sub-category data representing one or more of the one or more personal travel sub-categories, the user is automatically presented the matched personal travel sub-category as a categorization option.

Likewise, in accordance with one embodiment, once the user categorizes a trip as business travel by selecting an uncategorized trip listed in the uncategorized travel display and making a sweeping motion to the business uncategorized travel display region of the uncategorized travel display, the portion of the travel data representing the business travel category categorized trip is processed to identify a match with a portion of the business travel sub-category data representing one or more of the one or more business travel sub-categories. In accordance with one embodiment, if a match is identified between the portion of the travel data representing the business travel category categorized trip and a portion of the business travel sub-category data representing one or more of the one or more business travel sub-categories, the user is automatically presented the matched business travel sub-category as a categorization option.

In one embodiment, the uncategorized travel display data includes estimated tax ramifications display region data for generating an estimated tax ramifications display region within the uncategorized travel display. In accordance with one embodiment, the estimated tax ramifications display region includes tax ramifications data indicating the tax ramifications associated with one or more travel/trips designated as business travel/trips. In accordance with one embodiment, once the user categorizes a trip as a business trip by selecting an uncategorized trip listed in the uncategorized travel display and making a sweeping motion to the business uncategorized travel display region of the uncategorized travel display, the portion of the travel data representing the business travel category categorized travel is processed to determine the estimated tax ramifications of the business travel category categorized travel and the estimated tax ramifications data is updated to reflect the estimated tax ramifications associated with the business travel category categorized travel.

Using the method and system for providing an intuitive and interactive travel categorization display discussed above, the user is provided a visual representation of the user's uncategorized travel/trips and is provided the capability to categorize the uncategorized travel/trips by simply selecting the uncategorized travel/trips and making a swiping motion towards the relevant portion of the interactive uncategorized travel display.

Consequently using the method and system for providing an intuitive and interactive travel categorization display discussed above provides a solution to the long standing problem of presenting users their financial information in an efficient, intuitive, interactive, and dynamic way that is of practical use. Therefore, the method and system for providing an intuitive and interactive travel categorization display discussed above significantly improves the technical fields of data entry/selection and user experience. Specifically, a user's experience is improved and simplified using embodiments of the present disclosure so that the user experience is less burdensome and more “game-like” in its interactions and user experience. Therefore, the user is more motivated to actively participate in the spending analysis and, by simplifying and speeding up the process of categorization, the user is allowed to dedicate more of his or her time to other activities. Therefore, implementations of embodiments of the present disclosure represent a significant improvement to the field of user experience and, in particular, efficient use of human and non-human resources.

In addition, by eliminating the necessity of performing unnecessary analysis and displaying detailed, and often undesired, reports and data, there is less data entry, less processing of data, and fewer errors in entered data. Consequently, using the method and system for providing an intuitive and interactive travel categorization display discussed above, fewer processor cycles are utilized, memory utilization is reduced, and less communications bandwidth is utilized to relay data to and from backend systems. As a result, computing systems, and particularly mobile computing systems, are transformed into faster, more efficient, and more effective computing systems by implementing the method and system for providing an intuitive and interactive travel categorization display discussed above.

The various embodiments of the method and system for providing an intuitive and interactive travel categorization display discussed above, and their associated benefits, also improve the technical field of financial management by providing users with a relevant and simple spending and financial display while requiring minimal user input, and the ability to provide that user input in an efficient manner. In addition, embodiments of the method and system for providing an intuitive and interactive travel categorization display discussed above allow the financial management system to offer a more relevant analysis of a user's financial situation. Further, the increased relevancy of the data provided using the method and system for providing an intuitive and interactive travel categorization display discussed above increase the chances that a user will continue using the financial management system.

As a result, using implementations of the method and system for providing an intuitive and interactive travel categorization display discussed above, the fields of financial management, travel data processing, data entry, data display, data processing, and user experience are significantly improved.

### Process

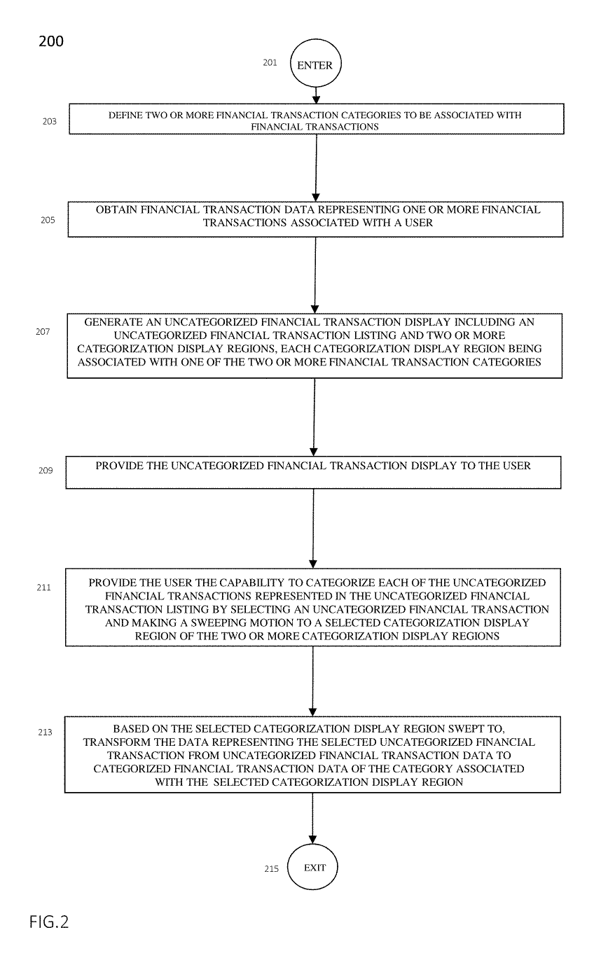

FIG. 2 is a flow chart representing one example of a process 200 for providing an intuitive and interactive financial transaction categorization display in accordance with one embodiment.

As seen in FIG. 2, process 200 for providing an intuitive and interactive financial transaction categorization display begins at ENTER OPERATION 201 and process flow proceeds to DEFINE TWO OR MORE FINANCIAL TRANSACTION CATEGORIES TO BE ASSOCIATED WITH FINANCIAL TRANSACTIONS OPERATION 203.

In one embodiment, at DEFINE TWO OR MORE FINANCIAL TRANSACTION CATEGORIES TO BE ASSOCIATED WITH FINANCIAL TRANSACTIONS OPERATION 203, two or more financial transaction categories to be applied to, or otherwise associated with, one or more financial transactions represented in financial transaction data are defined.

In various embodiments, the financial transaction categories represent financial transaction categories used to categorize and process various financial transactions associated with the user. In various embodiments, the financial transaction categories are defined by the provider of the process 200 for providing an intuitive and interactive financial transaction categorization display. In other embodiments, the financial transaction categories are defined by one or more financial management systems such as, but not limited to, any of the financial management systems as discussed herein, and/or as known in the art at the time of filing, and/or as developed after the time of filing.

Herein, a financial management system can be, but is not limited to, any data management system that gathers financial data, including financial transactional data, from one or more sources, such as financial accounts and financial institutions, and/or has the capability to analyze and categorize at least part of the financial transaction data.

In some embodiments, the financial transaction categories are defined by outside agencies such as, but not limited to, the Internal Revenue Service (IRS) or other state and local tax agencies.

In one embodiment, the financial transaction categories are broad financial transaction categories that include, or encompass, one or more of financial transaction sub-categories as discussed below. In one embodiment, the financial transaction categories are defined in pairs of financial transaction categories that are representative of a broad categorization of various subsets of financial transaction categories.

For instance, in one specific example, the pair of financial transaction categories include “personal” and “business” financial transaction categories where the “personal” financial transaction category is applied to personal related expenses as opposed to “business” related expenses that have tax ramifications.

As noted above, one long standing problem associated with traditional financial management system displays is the inability to present users their financial information in an efficient, relevant, intuitive, interactive, and dynamic way that is of practical use. However, in the disclosed embodiments, by dividing the user's spending transactions between relatively few, in one embodiment only two, financial transaction categories, the user is provided a straightforward display including, in one specific illustrative example, only personal and business financial transaction categories.

Other examples of pairs of financial transaction categories include any financial transaction categories as discussed herein, and/or as known in the art at the time of filing, and/or as developed after the time of filing.

In one embodiment, once two or more financial transaction categories to be applied to, or otherwise associated with, one or more financial transactions represented in financial transaction data are defined and financial transaction category data representing the defined financial transaction categories is generated at DEFINE TWO OR MORE FINANCIAL TRANSACTION CATEGORIES TO BE ASSOCIATED WITH FINANCIAL TRANSACTIONS OPERATION 203, process flow proceeds to OBTAIN FINANCIAL TRANSACTION DATA REPRESENTING ONE OR MORE FINANCIAL TRANSACTIONS ASSOCIATED WITH A USER OPERATION 205.

In one embodiment, at OBTAIN FINANCIAL TRANSACTION DATA REPRESENTING ONE OR MORE FINANCIAL TRANSACTIONS ASSOCIATED WITH A USER OPERATION 205, financial transaction data is obtained from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing.

In one embodiment, once the financial transaction data is obtained at OBTAIN FINANCIAL TRANSACTION DATA REPRESENTING ONE OR MORE FINANCIAL TRANSACTIONS ASSOCIATED WITH A USER OPERATION 205, the financial transaction data is subjected to an initial processing whereby the financial transaction data is analyzed with rules data representing one or more automated initial categorization rules.

In various embodiments, the one or more automated initial categorization rules represented by the rules data is generated by/obtained from one or more of the provider of the method and system for providing an intuitive and interactive financial transaction categorization display, the user, and/or one or more financial management systems. In one embodiment, the one or more automated initial categorization rules represented by the rules data is generated by, and/or updated, based on historical categorizations of financial transactions by the user so that the one or more automated initial categorization rules are continuously updated based on actions taken by the user and customized to the user.

In one embodiment, as a result of the financial transaction data being initially processed in accordance with rules data representing one or more automated categorization rules at OBTAIN FINANCIAL TRANSACTION DATA REPRESENTING ONE OR MORE FINANCIAL TRANSACTIONS ASSOCIATED WITH A USER OPERATION 205, some of the financial transactions represented by part of the financial transaction data are categorized automatically as the financial transaction data is received. Consequently, as a result of the financial transaction data being initially processed in accordance with rules data a categorized portion of the financial transaction data is transformed into initially categorized financial transaction data representing financial transactions categorized according to the rules data as being in either the first or second financial transaction categories. Likewise, an uncategorized portion of the financial transaction data representing financial transactions that are not categorized according to the rules data as being in either the first or second financial transaction categories is also generated/defined.

In one embodiment, once financial transaction data is obtained from one or more financial management systems and/or other financial transaction data sources at OBTAIN FINANCIAL TRANSACTION DATA REPRESENTING ONE OR MORE FINANCIAL TRANSACTIONS ASSOCIATED WITH A USER OPERATION 205, process flow proceeds to GENERATE AN UNCATEGORIZED FINANCIAL TRANSACTION DISPLAY INCLUDING AN UNCATEGORIZED FINANCIAL TRANSACTION LISTING AND TWO OR MORE CATEGORIZATION DISPLAY REGIONS, EACH CATEGORIZATION DISPLAY REGION BEING ASSOCIATED WITH ONE OF THE TWO OR MORE FINANCIAL TRANSACTION CATEGORIES OPERATION 207.

In one embodiment, at GENERATE AN UNCATEGORIZED FINANCIAL TRANSACTION DISPLAY INCLUDING AN UNCATEGORIZED FINANCIAL TRANSACTION LISTING AND TWO OR MORE CATEGORIZATION DISPLAY REGIONS, EACH CATEGORIZATION DISPLAY REGION BEING ASSOCIATED WITH ONE OF THE TWO OR MORE FINANCIAL TRANSACTION CATEGORIES OPERATION 207, uncategorized financial transaction display data for generating an uncategorized financial transaction display is generated.

In one embodiment, the intuitive and interactive financial transaction categorization display generated by the uncategorized financial transaction display data includes an uncategorized financial transaction listing region including a listing of the uncategorized financial transactions represented by the uncategorized portion of the financial transaction data. Consequently, in accordance with one embodiment, the uncategorized financial transaction display data includes uncategorized financial transaction listing data for generating a listing of the uncategorized financial transactions represented by the uncategorized portion of the financial transaction data in the uncategorized financial transactions listing region of the uncategorized financial transaction display.

In one embodiment, the uncategorized financial transaction listing region of the intuitive and interactive financial transaction categorization display includes an uncategorized financial transaction listing displaying the individual uncategorized financial transactions not yet mapped to either the first or second financial transaction categories. In one embodiment, the uncategorized financial transaction listing region is positioned approximately halfway between the first and second uncategorized financial transaction display regions discussed below.

In accordance with one embodiment, the uncategorized financial transaction display includes at least two uncategorized financial transaction display regions, or directions: a first uncategorized financial transaction display region/direction and a second uncategorized financial transaction display region/direction. Consequently, in one embodiment, the uncategorized financial transaction display data includes financial transaction categorization display regions data for defining the at least two uncategorized financial transaction display regions/directions.

In accordance with one embodiment, the first uncategorized financial transaction display region is associated with the first financial transaction category such that when a given uncategorized financial transaction is selected and then a sweeping motion is made by the user towards the first uncategorized financial transaction display region/direction, the given uncategorized financial transaction is transformed into a first financial transaction category financial transaction. In accordance with one embodiment, the second uncategorized financial transaction display region is associated with the second financial transaction category such that when a given uncategorized financial transaction is selected and then a sweeping motion is made towards the second uncategorized financial transaction display region/direction, the given uncategorized financial transaction is transformed into a second financial transaction category financial transaction.

In various embodiments, the first and second uncategorized financial transaction display regions/directions are visually distinguishable from each other and represented as physically removed from one another. For instance, as a specific illustrative example, in one embodiment, the first display region of the uncategorized financial transaction display is associated with a first color and is displayed in a first display region on a first side of the uncategorized financial transaction display, while the second display region of the uncategorized financial transaction display is of a second color and is displayed in a second display region on a second side of the uncategorized financial transaction display.

In various other embodiments, the first display region of the uncategorized financial transaction display is associated with any graphic of any color and is displayed in a first display region in any region of the intuitive and interactive financial transaction categorization display, while the second display region of the uncategorized financial transaction display is associated with any graphic of any color and is displayed in a second display region in any different region of the intuitive and interactive financial transaction categorization display.

In accordance with one embodiment, the uncategorized financial transaction display data is used to generate an uncategorized financial transaction display including an uncategorized financial transactions listing region, a first uncategorized financial transaction display region, and a second uncategorized financial transaction display region.

In one embodiment, once uncategorized financial transaction display data for generating an uncategorized financial transaction display is generated at GENERATE AN UNCATEGORIZED FINANCIAL TRANSACTION DISPLAY INCLUDING AN UNCATEGORIZED FINANCIAL TRANSACTION LISTING AND TWO OR MORE CATEGORIZATION DISPLAY REGIONS, EACH CATEGORIZATION DISPLAY REGION BEING ASSOCIATED WITH ONE OF THE TWO OR MORE FINANCIAL TRANSACTION CATEGORIES OPERATION 207, process flow proceeds to PROVIDE THE UNCATEGORIZED FINANCIAL TRANSACTION DISPLAY TO THE USER OPERATION 209.

In one embodiment, at PROVIDE THE UNCATEGORIZED FINANCIAL TRANSACTION DISPLAY TO THE USER OPERATION 209, the intuitive and interactive financial transaction categorization display is provided to the user on a display screen of a user computing system owed, accessible by, or otherwise associated with, the user.

In various embodiments, the user computing system is any computing system as discussed herein, and/or as known in the art at the time of filing, and/or as developed after the time of filing.

In various embodiments, the display screen of the user computing system is a touch screen, or other interactive display screen capable of receiving user input via touch, stylus, or other user input device or mechanism, as discussed herein, and/or as known in the art at the time of filing, and/or as developed after the time of filing.

In one embodiment, once the intuitive and interactive financial transaction categorization display is provided to the user on a display screen of a user computing system owed, accessible by, or otherwise associated with, the user at PROVIDE THE UNCATEGORIZED FINANCIAL TRANSACTION DISPLAY TO THE USER OPERATION 209, process flow proceeds to PROVIDE THE USER THE CAPABILITY TO CATEGORIZE EACH OF THE UNCATEGORIZED FINANCIAL TRANSACTIONS REPRESENTED IN THE UNCATEGORIZED FINANCIAL TRANSACTION LISTING BY SELECTING AN UNCATEGORIZED FINANCIAL TRANSACTION AND MAKING A SWEEPING MOTION TO A SELECTED CATEGORIZATION DISPLAY REGION OF THE TWO OR MORE CATEGORIZATION DISPLAY REGIONS OPERATION 211.

In one embodiment, at PROVIDE THE USER THE CAPABILITY TO CATEGORIZE EACH OF THE UNCATEGORIZED FINANCIAL TRANSACTIONS REPRESENTED IN THE UNCATEGORIZED FINANCIAL TRANSACTION LISTING BY SELECTING AN UNCATEGORIZED FINANCIAL TRANSACTION AND MAKING A SWEEPING MOTION TO A SELECTED CATEGORIZATION DISPLAY REGION OF THE TWO OR MORE CATEGORIZATION DISPLAY REGIONS OPERATION 211, the user is provided the opportunity to dynamically and intuitively categorize each of the uncategorized financial transactions in either the first financial transaction category or the second financial transaction category.

In accordance with one embodiment, the user is provided the capability to categorize each of the uncategorized financial transactions represented by the uncategorized financial transaction listing data of the uncategorized financial transaction display data by selecting an uncategorized financial transaction listed in the uncategorized financial transaction display and making a sweeping motion to, or in the direction of, either the first or second region of the uncategorized financial transaction display.

In one embodiment, once the user is provided the opportunity to dynamically and intuitively categorize each of the uncategorized financial transactions in either the first financial transaction category or the second financial transaction category at PROVIDE THE USER THE CAPABILITY TO CATEGORIZE EACH OF THE UNCATEGORIZED FINANCIAL TRANSACTIONS REPRESENTED IN THE UNCATEGORIZED FINANCIAL TRANSACTION LISTING BY SELECTING AN UNCATEGORIZED FINANCIAL TRANSACTION AND MAKING A SWEEPING MOTION TO A SELECTED CATEGORIZATION DISPLAY REGION OF THE TWO OR MORE CATEGORIZATION DISPLAY REGIONS OPERATION 211, process flow proceeds to BASED ON THE SELECTED CATEGORIZATION DISPLAY REGION SWEPT TO, TRANSFORM THE DATA REPRESENTING THE SELECTED UNCATEGORIZED FINANCIAL TRANSACTION FROM UNCATEGORIZED FINANCIAL TRANSACTION DATA TO CATEGORIZED FINANCIAL TRANSACTION DATA OF THE CATEGORY ASSOCIATED WITH THE SELECTED CATEGORIZATION DISPLAY REGION OPERATION 213.

In one embodiment, at BASED ON THE SELECTED CATEGORIZATION DISPLAY REGION SWEPT TO, TRANSFORM THE DATA REPRESENTING THE SELECTED UNCATEGORIZED FINANCIAL TRANSACTION FROM UNCATEGORIZED FINANCIAL TRANSACTION DATA TO CATEGORIZED FINANCIAL TRANSACTION DATA OF THE CATEGORY ASSOCIATED WITH THE SELECTED CATEGORIZATION DISPLAY REGION OPERATION 213, a selected uncategorized financial transaction swept to the first region of the uncategorized financial transaction display is automatically categorized as a member of first financial transaction category by transforming the portion of the uncategorized financial transaction listing data representing the uncategorized financial transaction to first financial transaction category categorized financial transaction listing data representing the formerly uncategorized financial transaction as a first financial transaction category financial transaction.

Likewise, in accordance with one embodiment, a selected uncategorized financial transaction swept to the second region of the uncategorized financial transaction display is automatically categorized as a member of second financial transaction category by transforming the portion of the uncategorized financial transaction listing data representing the uncategorized financial transaction to second financial transaction category categorized financial transaction listing data representing the formerly uncategorized financial transaction as a second financial transaction category financial transaction.

In one embodiment, one or more financial transaction sub-categories associated with the first and second financial transaction categories are defined and first and second financial transaction category sub-categories data is generated.

In accordance with one embodiment, elements of first and second financial transaction category categorized financial transaction listing data are mapped to the first and second financial transaction category sub-categories data such that, in accordance with one embodiment, once the user categorizes a financial transaction as a first financial transaction by selecting an uncategorized financial transaction listed in the uncategorized financial transaction display and making a sweeping motion to the first uncategorized financial transaction display region of the uncategorized financial transaction display, the portion of the financial transaction data representing the first financial transaction category categorized financial transaction is processed to identify a match with a portion of the first financial transaction sub-category data representing one or more of the one or more first financial transaction sub-categories. In accordance with one embodiment, if a match is identified between the portion of the financial transaction data representing the first financial transaction category categorized financial transaction and a portion of the first financial transaction sub-category data representing one or more of the one or more first financial transaction sub-categories, the user is automatically presented the matched first financial transaction sub-category as a categorization option.

Likewise, in accordance with one embodiment, once the user categorizes a financial transaction as a second financial transaction by selecting an uncategorized financial transaction listed in the uncategorized financial transaction display and making a sweeping motion to the second uncategorized financial transaction display region of the uncategorized financial transaction display, the portion of the financial transaction data representing the second financial transaction category categorized financial transaction is processed to identify a match with a portion of the second financial transaction sub-category data representing one or more of the one or more second financial transaction sub-categories. In accordance with one embodiment, if a match is identified between the portion of the financial transaction data representing the second financial transaction category categorized financial transaction and a portion of the second financial transaction sub-category data representing one or more of the one or more second financial transaction sub-categories, the user is automatically presented the matched second financial transaction sub-category as a categorization option.

In one embodiment, once based on the selected categorization display region swept to, the data representing the selected uncategorized financial transaction from uncategorized financial transaction data is transformed to categorized financial transaction data of the category associated with the selected categorization display region at BASED ON THE SELECTED CATEGORIZATION DISPLAY REGION SWEPT TO, TRANSFORM THE DATA REPRESENTING THE SELECTED UNCATEGORIZED FINANCIAL TRANSACTION FROM UNCATEGORIZED FINANCIAL TRANSACTION DATA TO CATEGORIZED FINANCIAL TRANSACTION DATA OF THE CATEGORY ASSOCIATED WITH THE SELECTED CATEGORIZATION DISPLAY REGION OPERATION 213, process flow proceeds to EXIT OPERATION 215.

In one embodiment, at EXIT OPERATION 215 process 200 for providing an intuitive and interactive financial transaction categorization display is exited to await new data.

Using the process 200 for providing an intuitive and interactive financial transaction categorization display, the user is provided a visual representation of the user's uncategorized financial transactions and is provided the capability to categorize the uncategorized financial transactions by simply selecting the uncategorized financial transactions and making a swiping motion towards the relevant portion of the interactive uncategorized financial transaction display.

Consequently, process 200 for providing an intuitive and interactive financial transaction categorization display provides a solution to the long standing problem of presenting users their financial information in an efficient, intuitive, interactive, and dynamic way that is of practical use. Therefore, process 200 for providing an intuitive and interactive financial transaction categorization display significantly improves the technical fields of data entry/selection and user experience. Specifically, a user's experience is improved and simplified using embodiments of the present disclosure so that the user experience is less burdensome and more “game-like” in its interactions and user experience. Therefore, the user is more motivated to actively participate in the spending analysis and, by simplifying and speeding up the process of categorization, the user is allowed to dedicate more of his or her time to other activities. Therefore, implementations of embodiments of the present disclosure represent a significant improvement to the field of user experience and, in particular, efficient use of human and non-human resources.

In addition, by eliminating the necessity of performing unnecessary analysis and displaying detailed, and often undesired, reports and data, there is less data entry, less processing of data, and fewer errors in entered data. Consequently, using process 200 for providing an intuitive and interactive financial transaction categorization display, fewer processor cycles are utilized, memory utilization is reduced, and less communications bandwidth is utilized to relay data to and from backend systems. As a result, computing systems, and particularly mobile computing systems, are transformed into faster, more efficient, and more effective computing systems by implementing process 200 for providing an intuitive and interactive financial transaction categorization display.

The various embodiments of process 200 for providing an intuitive and interactive financial transaction categorization display and their associated benefits also improve the technical field of financial management by providing users with a relevant and simple spending and financial display while requiring minimal user input, and the ability to provide that user input in an efficient manner. In addition, embodiments of process 200 for providing an intuitive and interactive financial transaction categorization display allow the financial management system to offer a more relevant analysis of a user's financial situation. Further, the increased relevancy of the data provided using process 200 for providing an intuitive and interactive financial transaction categorization display increase the chances that a user will continue using the financial management system.

As a result, using implementations of process 200 for providing an intuitive and interactive financial transaction categorization display, the fields of financial management, financial transaction data processing, data entry, data display, data processing, and user experience are significantly improved.

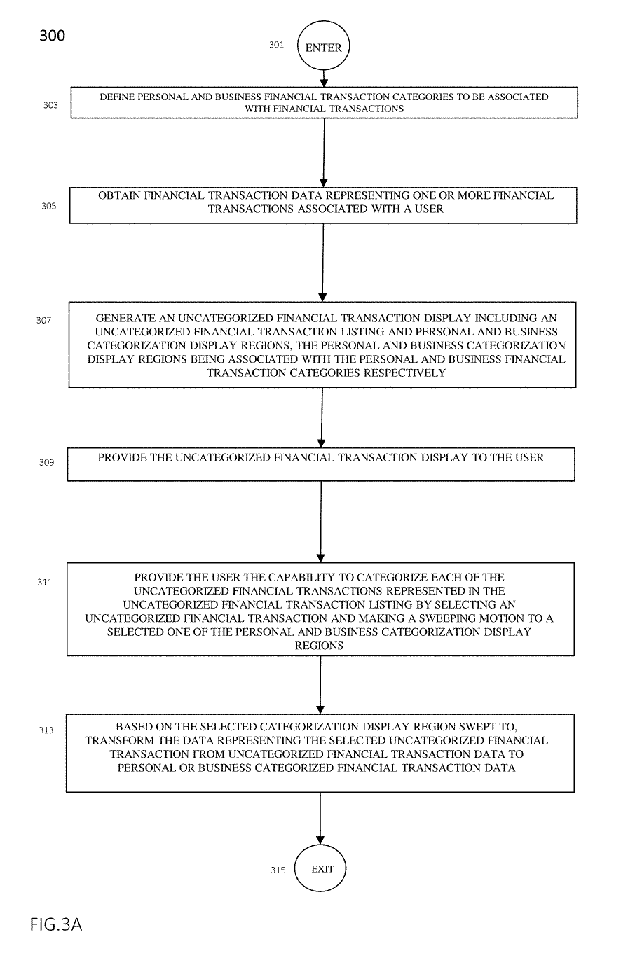

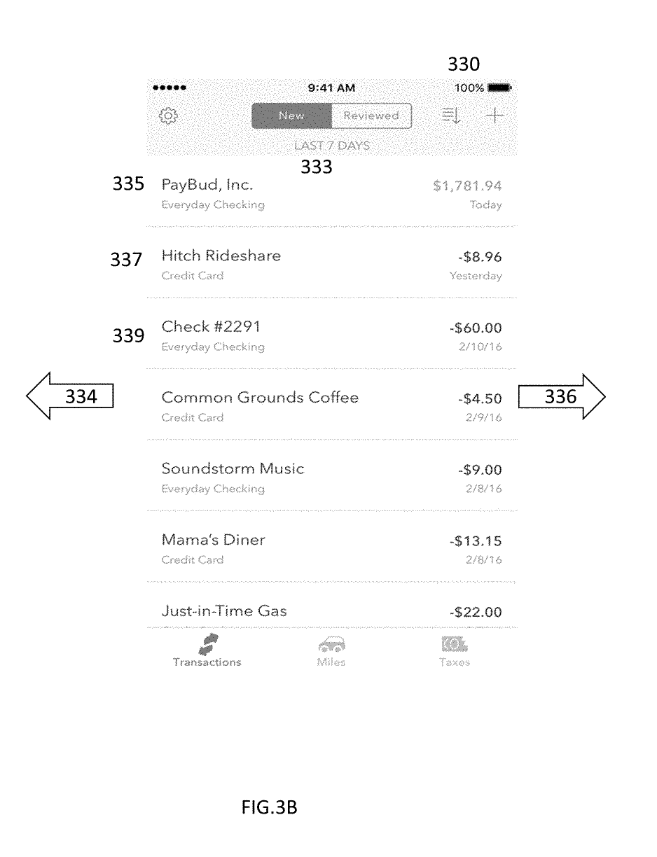

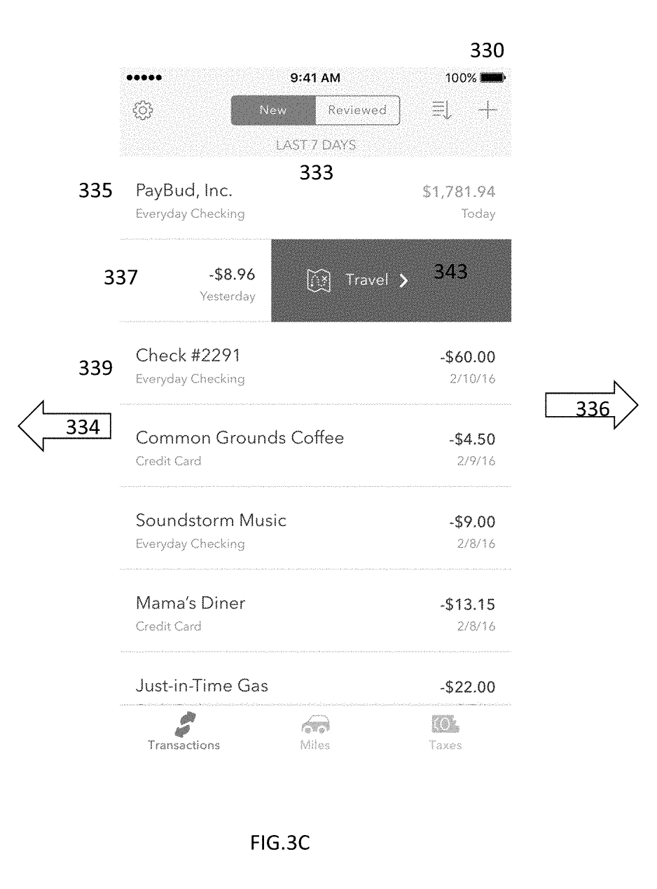

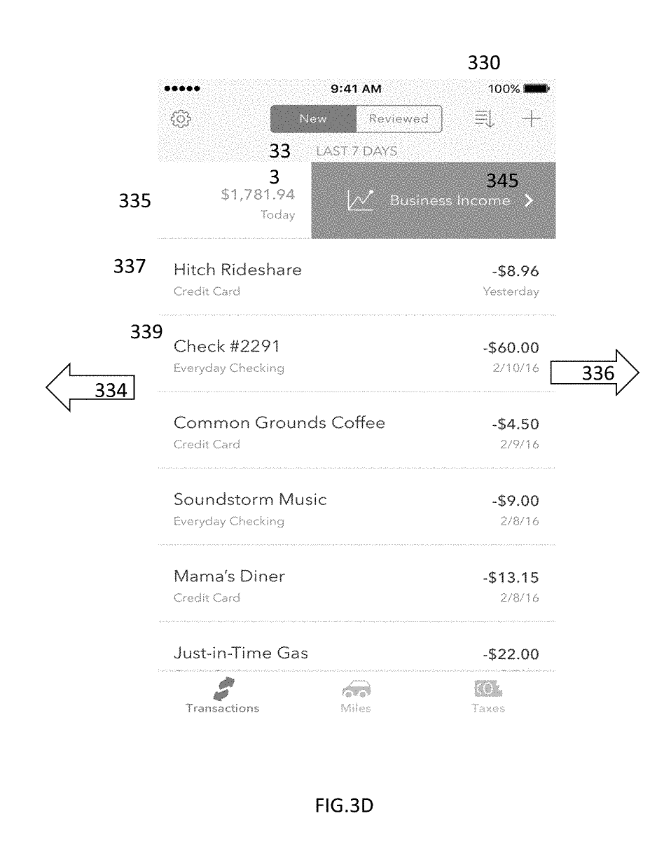

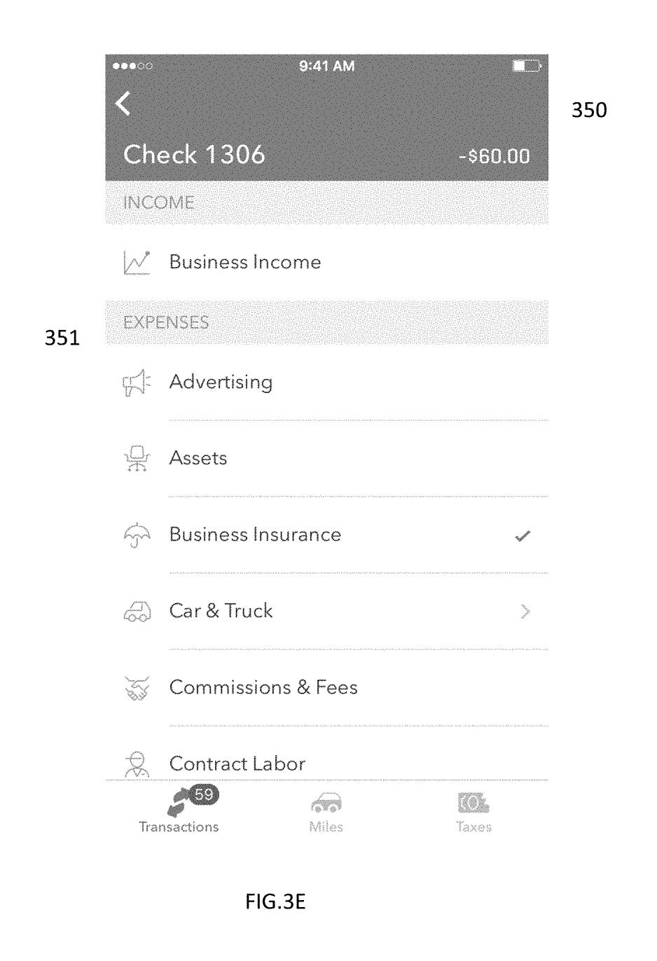

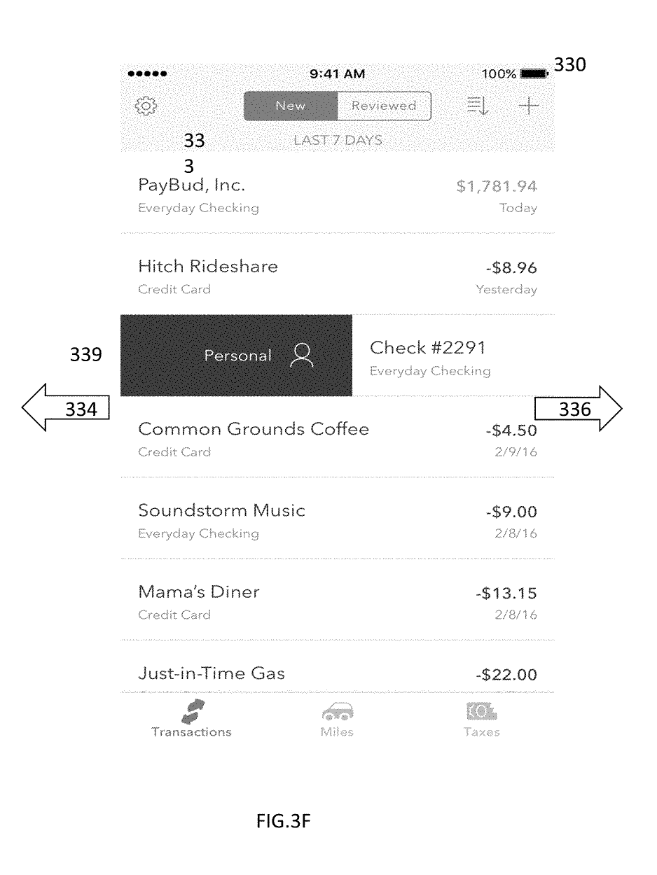

FIG. 3A is a flow chart representing one example of a process 300 for providing an intuitive and interactive financial transaction categorization display in accordance with one embodiment. FIGS. 3B, 3C, 3D, 3E, and 3F represent specific illustrative examples of display screens associated with process 300 for providing an intuitive and interactive financial transaction categorization display in accordance with one embodiment.

Referring to FIGS. 3A, 3B, 3C, 3D, 3E, and 3F together, process 300 for providing an intuitive and interactive financial transaction categorization display begins at ENTER OPERATION 301 and process flow proceeds to DEFINE PERSONAL AND BUSINESS FINANCIAL TRANSACTION CATEGORIES TO BE ASSOCIATED WITH FINANCIAL TRANSACTIONS OPERATION 303.

In one embodiment, at DEFINE PERSONAL AND BUSINESS FINANCIAL TRANSACTION CATEGORIES TO BE ASSOCIATED WITH FINANCIAL TRANSACTIONS OPERATION 303, personal and business financial transaction categories to be applied to, or otherwise associated with, one or more financial transactions represented in financial transaction data are defined.

In various embodiments, the personal and business financial transaction categories represent financial transaction categories used to categorize and process various financial transactions associated with the user.

As noted above, one long standing problem associated with traditional financial management system displays is the inability to present users their financial information in an efficient, relevant, intuitive, interactive, and dynamic way that is of practical use. However, in the disclosed embodiments, by dividing the user's spending transactions between relatively few, in one embodiment only two, financial transaction categories, the user is provided a straightforward display including, in one specific illustrative example, only personal and business financial transaction categories.

In one embodiment, once personal and business financial transaction categories to be applied to, or otherwise associated with, one or more financial transactions represented in financial transaction data are defined and data representing the defined financial transaction categories is generated at DEFINE PERSONAL AND BUSINESS FINANCIAL TRANSACTION CATEGORIES TO BE ASSOCIATED WITH FINANCIAL TRANSACTIONS OPERATION 303, process flow proceeds to OBTAIN FINANCIAL TRANSACTION DATA REPRESENTING ONE OR MORE FINANCIAL TRANSACTIONS ASSOCIATED WITH A USER OPERATION 305.

In one embodiment, at OBTAIN FINANCIAL TRANSACTION DATA REPRESENTING ONE OR MORE FINANCIAL TRANSACTIONS ASSOCIATED WITH A USER OPERATION 305, financial transaction data is obtained from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing.

In one embodiment, once the financial transaction data is obtained, the financial transaction data is subjected to an initial processing whereby the financial transaction data is analyzed with rules data representing one or more automated initial categorization rules.

In various embodiments, the one or more automated initial categorization rules represented by the rules data is generated by/obtained from one or more of the provider of the process 300 for providing an intuitive and interactive financial transaction categorization display, the user, and/or one or more financial management systems. In one embodiment, the one or more automated initial categorization rules represented by the rules data is generated by, and/or updated, based on historical categorizations of financial transactions by the user so that the one or more automated initial categorization rules are continuously updated based on actions taken by the user and customized to the user.

In one embodiment, as a result of the financial transaction data being initially processed in accordance with rules data representing one or more automated categorization rules, some of the financial transactions represented by part of the financial transaction data are categorized automatically as the financial transaction data is received. Consequently, as a result of the financial transaction data being initially processed in accordance with rules data, a categorized portion of the financial transaction data is transformed into initially categorized financial transaction data representing financial transactions categorized according to the rules data as being in either the personal or business financial transaction categories. Likewise, an uncategorized portion of the financial transaction data representing financial transactions that are not categorized according to the rules data as being in either the personal or business financial transaction categories is also generated/defined.

In one embodiment, once financial transaction data is obtained from one or more financial management systems and/or other financial transaction data sources, such as any of the financial management systems and/or other financial transaction data sources discussed herein, and/or as known in the art at the time of filing, and/or as developed after the time of filing, and/or by any means as discussed herein, and/or as known in the art at the time of filing, and/or as becomes known after the time of filing at OBTAIN FINANCIAL TRANSACTION DATA REPRESENTING ONE OR MORE FINANCIAL TRANSACTIONS ASSOCIATED WITH A USER OPERATION 305, process flow proceeds to GENERATE AN UNCATEGORIZED FINANCIAL TRANSACTION DISPLAY INCLUDING AN UNCATEGORIZED FINANCIAL TRANSACTION LISTING AND PERSONAL AND BUSINESS CATEGORIZATION DISPLAY REGIONS, THE PERSONAL AND BUSINESS CATEGORIZATION DISPLAY REGIONS BEING ASSOCIATED WITH THE PERSONAL AND BUSINESS FINANCIAL TRANSACTION CATEGORIES RESPECTIVELY OPERATION 307.

In one embodiment, at GENERATE AN UNCATEGORIZED FINANCIAL TRANSACTION DISPLAY INCLUDING AN UNCATEGORIZED FINANCIAL TRANSACTION LISTING AND PERSONAL AND BUSINESS CATEGORIZATION DISPLAY REGIONS, THE PERSONAL AND BUSINESS CATEGORIZATION DISPLAY REGIONS BEING ASSOCIATED WITH THE PERSONAL AND BUSINESS FINANCIAL TRANSACTION CATEGORIES RESPECTIVELY OPERATION 307, uncategorized financial transaction display data for generating an uncategorized financial transaction display is generated.

In one embodiment, the intuitive and interactive financial transaction categorization display generated by the uncategorized financial transaction display data includes an uncategorized financial transaction listing region including a listing of the uncategorized financial transactions represented by the uncategorized portion of the financial transaction data. Consequently, in accordance with one embodiment, the uncategorized financial transaction display data includes uncategorized financial transaction listing data for generating a listing of the uncategorized financial transactions represented by the uncategorized portion of the financial transaction data in the uncategorized financial transactions listing region of the uncategorized financial transaction display.

In one embodiment, the uncategorized financial transaction listing region of the intuitive and interactive financial transaction categorization display includes an uncategorized financial transaction listing displaying the individual uncategorized financial transactions not yet mapped to either the personal or business financial transaction categories. In one embodiment, the uncategorized financial transaction listing region is positioned approximately halfway between the personal and business uncategorized financial transaction display regions discussed below.

In accordance with one embodiment, the uncategorized financial transaction display includes at least two uncategorized financial transaction display regions, or directions: a personal uncategorized financial transaction display region/direction and a business uncategorized financial transaction display region/direction. Consequently, in one embodiment, the uncategorized financial transaction display data includes financial transaction categorization display regions data for defining the personal and business uncategorized financial transaction display regions/directions.

In accordance with one embodiment, the personal uncategorized financial transaction display region is associated with the personal financial transaction category such that when a given uncategorized financial transaction is selected and then a sweeping motion is made by the user towards the personal uncategorized financial transaction display region/direction, the given uncategorized financial transaction is transformed into a personal financial transaction category financial transaction. In accordance with one embodiment, the business uncategorized financial transaction display region is associated with the business financial transaction category such that when a given uncategorized financial transaction is selected and then a sweeping motion is made towards the business uncategorized financial transaction display region/direction, the given uncategorized financial transaction is transformed into a business financial transaction category financial transaction.

In various embodiments, the personal and business uncategorized financial transaction display regions/directions are visually distinguishable from each other and represented as physically removed from one another. For instance, as a specific illustrative example, in one embodiment, the personal display region of the uncategorized financial transaction display is associated with a first color and is displayed in a personal display region on a first side of the uncategorized financial transaction display, while the business display region of the uncategorized financial transaction display is of a second color and is displayed in a business display region on a second side of the uncategorized financial transaction display.

In various other embodiments, the personal display region of the uncategorized financial transaction display is associated with any graphic of any color and is displayed in a personal display region in any region of the intuitive and interactive financial transaction categorization display, while the business display region of the uncategorized financial transaction display is associated with any graphic of any color and is displayed in a business display region in any different region of the intuitive and interactive financial transaction categorization display.

In one embodiment, once uncategorized financial transaction display data for generating an uncategorized financial transaction display is generated at GENERATE AN UNCATEGORIZED FINANCIAL TRANSACTION DISPLAY INCLUDING AN UNCATEGORIZED FINANCIAL TRANSACTION LISTING AND PERSONAL AND BUSINESS CATEGORIZATION DISPLAY REGIONS, THE PERSONAL AND BUSINESS CATEGORIZATION DISPLAY REGIONS BEING ASSOCIATED WITH THE PERSONAL AND BUSINESS FINANCIAL TRANSACTION CATEGORIES RESPECTIVELY OPERATION 307, process flow proceeds to PROVIDE THE UNCATEGORIZED FINANCIAL TRANSACTION DISPLAY TO THE USER OPERATION 309.

In one embodiment, at PROVIDE THE UNCATEGORIZED FINANCIAL TRANSACTION DISPLAY TO THE USER OPERATION 309, the uncategorized financial transaction display data is used to generate an uncategorized financial transaction display such as uncategorized financial transaction display 330 of FIGS. 3B, 3C, 3D, and 3F, including, but not limited to: an uncategorized financial transactions listing region, such as uncategorized financial transactions listing region 333 of FIGS. 3B, 3C, 3D, and 3F; a personal uncategorized financial transaction display region/direction, such as personal uncategorized financial transaction display region/direction 334 of FIGS. 3B, 3C, 3D, and 3F; and a business uncategorized financial transaction display region, such as business uncategorized financial transaction display region 336 of FIGS. 3B, 3C, 3D, and 3F.

In accordance with one embodiment, the intuitive and interactive financial transaction categorization display is provided to the user on a display screen of a user computing system owed, accessible by, or otherwise associated with, the user.

In various embodiments, the user computing system is any computing system as discussed herein, and/or as known in the art at the time of filing, and/or as developed after the time of filing.

In various embodiments, the display screen of the user computing system is a touch screen, or other interactive display screen capable of receiving user input via touch, stylus, or other user input device or mechanism, as discussed herein, and/or as known in the art at the time of filing, and/or as developed after the time of filing.

In one embodiment, once the uncategorized financial transaction display data is used to generate an uncategorized financial transaction display including an uncategorized financial transactions listing region, a personal uncategorized financial transaction display region, and a business uncategorized financial transaction display region and the intuitive and interactive financial transaction categorization display is provided to the user on a display screen of a user computing system owed, accessible by, or otherwise associated with, the user at PROVIDE THE UNCATEGORIZED FINANCIAL TRANSACTION DISPLAY TO THE USER OPERATION 309, process flow proceeds to PROVIDE THE USER THE CAPABILITY TO CATEGORIZE EACH OF THE UNCATEGORIZED FINANCIAL TRANSACTIONS REPRESENTED IN THE UNCATEGORIZED FINANCIAL TRANSACTION LISTING BY SELECTING AN UNCATEGORIZED FINANCIAL TRANSACTION AND MAKING A SWEEPING MOTION TO A SELECTED ONE OF THE PERSONAL AND BUSINESS CATEGORIZATION DISPLAY REGIONS OPERATION 311.

In one embodiment, at PROVIDE THE USER THE CAPABILITY TO CATEGORIZE EACH OF THE UNCATEGORIZED FINANCIAL TRANSACTIONS REPRESENTED IN THE UNCATEGORIZED FINANCIAL TRANSACTION LISTING BY SELECTING AN UNCATEGORIZED FINANCIAL TRANSACTION AND MAKING A SWEEPING MOTION TO A SELECTED ONE OF THE PERSONAL AND BUSINESS CATEGORIZATION DISPLAY REGIONS OPERATION 311 the user is provided the opportunity to dynamically and intuitively categorize each of the uncategorized financial transactions in either the personal financial transaction category or the business financial transaction category.

In accordance with one embodiment, the user is provided the capability to categorize each of the uncategorized financial transactions represented by the uncategorized financial transaction listing data of the uncategorized financial transaction display data by selecting an uncategorized financial transaction listed in the uncategorized financial transaction display and making a sweeping motion to, or in the direction of, either the first or second region of the uncategorized financial transaction display.

As seen in FIGS. 3B, 3C, 3D and 3F, uncategorized financial transaction display 330 includes uncategorized financial transactions listing region 333 with uncategorized financial transactions 335, 337, 339 among others.

In accordance with one embodiment, the user is provided the capability to categorize each of the uncategorized financial transactions 335, 337, 339 represented in uncategorized financial transaction listing region 333 of uncategorized financial transaction display 330 by selecting an uncategorized financial transaction, such as uncategorized financial transactions 337 and making a sweeping motion to, or in the direction of personal uncategorized financial transaction display region/direction 334 or business uncategorized financial transaction display region 336.

In one embodiment, once the user is provided the opportunity to dynamically and intuitively categorize each of the uncategorized financial transactions in either the personal financial transaction category or the business financial transaction category at PROVIDE THE USER THE CAPABILITY TO CATEGORIZE EACH OF THE UNCATEGORIZED FINANCIAL TRANSACTIONS REPRESENTED IN THE UNCATEGORIZED FINANCIAL TRANSACTION LISTING BY SELECTING AN UNCATEGORIZED FINANCIAL TRANSACTION AND MAKING A SWEEPING MOTION TO A SELECTED ONE OF THE PERSONAL AND BUSINESS CATEGORIZATION DISPLAY REGIONS OPERATION 311, process flow proceeds to BASED ON THE SELECTED CATEGORIZATION DISPLAY REGION SWEPT TO, TRANSFORM THE DATA REPRESENTING THE SELECTED UNCATEGORIZED FINANCIAL TRANSACTION FROM UNCATEGORIZED FINANCIAL TRANSACTION DATA TO PERSONAL OR BUSINESS CATEGORIZED FINANCIAL TRANSACTION DATA OPERATION 313.

In one embodiment, at BASED ON THE SELECTED CATEGORIZATION DISPLAY REGION SWEPT TO, TRANSFORM THE DATA REPRESENTING THE SELECTED UNCATEGORIZED FINANCIAL TRANSACTION FROM UNCATEGORIZED FINANCIAL TRANSACTION DATA TO PERSONAL OR BUSINESS CATEGORIZED FINANCIAL TRANSACTION DATA OPERATION 313, based on the selected categorization display region swept to, the data representing the selected uncategorized financial transaction is transformed from uncategorized financial transaction data to personal or business categorized financial transaction data.

In accordance with one embodiment, a selected uncategorized financial transaction swept to the first region of the uncategorized financial transaction display is automatically categorized as a member of personal financial transaction category by transforming the portion of the uncategorized financial transaction listing data representing the uncategorized financial transaction to personal financial transaction category categorized financial transaction listing data representing the formerly uncategorized financial transaction as a personal financial transaction category financial transaction.

As seen in FIG. 3F, in accordance with one embodiment, a selected uncategorized financial transaction, such as selected uncategorized financial transaction 339 in FIG. 3F swept to the first region of the uncategorized financial transaction display, such as personal uncategorized financial transaction display region/direction 334 is automatically categorized as a member of personal financial transaction category by transforming the portion of the uncategorized financial transaction listing data representing the uncategorized financial transaction to personal financial transaction category categorized financial transaction listing data representing the formerly uncategorized financial transaction as a personal financial transaction category financial transaction.

Likewise, in accordance with one embodiment, a selected uncategorized financial transaction swept to the second region of the uncategorized financial transaction display is automatically categorized as a member of business financial transaction category by transforming the portion of the uncategorized financial transaction listing data representing the uncategorized financial transaction to business financial transaction category categorized financial transaction listing data representing the formerly uncategorized financial transaction as a business financial transaction category financial transaction.

As seen in FIGS. 3C and 3D, in accordance with one embodiment, a selected uncategorized financial transaction, such as selected uncategorized financial transaction 335 in FIG. 3D and selected uncategorized financial transaction 337 in FIG. 3C swept to the second region of the uncategorized financial transaction display, such as business uncategorized financial transaction display region 336 in FIGS. 3C and 3D, is automatically categorized as a member of business financial transaction category by transforming the portion of the uncategorized financial transaction listing data representing the uncategorized financial transaction to business financial transaction category categorized financial transaction listing data representing the formerly uncategorized financial transaction as a business financial transaction category financial transaction.

In one embodiment, one or more financial transaction sub-categories associated with the personal and business financial transaction categories are defined and personal and business financial transaction category sub-categories data is generated.

An illustrative example of financial transaction sub-categories associated with the business financial transaction category is shown in business financial transaction category sub-category listing 351 of business financial transaction category sub-category display 350 of FIG. 3E.

In accordance with one embodiment, elements of personal and business financial transaction category categorized financial transaction listing data are mapped to the personal and business financial transaction category sub-categories data such that, in accordance with one embodiment, once the user categorizes a financial transaction as a personal financial transaction by selecting an uncategorized financial transaction listed in the uncategorized financial transaction display and making a sweeping motion to the personal uncategorized financial transaction display region of the uncategorized financial transaction display, the portion of the financial transaction data representing the personal financial transaction category categorized financial transaction is processed to identify a match with a portion of the personal financial transaction sub-category data representing one or more of the one or more personal financial transaction sub-categories. In accordance with one embodiment, if a match is identified between the portion of the financial transaction data representing the personal financial transaction category categorized financial transaction and a portion of the personal financial transaction sub-category data representing one or more of the one or more personal financial transaction sub-categories, the user is automatically presented the matched personal financial transaction sub-category as a categorization option.

Likewise, in accordance with one embodiment, once the user categorizes a financial transaction as a business financial transaction by selecting an uncategorized financial transaction listed in the uncategorized financial transaction display and making a sweeping motion to the business uncategorized financial transaction display region of the uncategorized financial transaction display, the portion of the financial transaction data representing the business financial transaction category categorized financial transaction is processed to identify a match with a portion of the business financial transaction sub-category data representing one or more of the one or more business financial transaction sub-categories. In accordance with one embodiment, if a match is identified between the portion of the financial transaction data representing the business financial transaction category categorized financial transaction and a portion of the business financial transaction sub-category data representing one or more of the one or more business financial transaction sub-categories, the user is automatically presented the matched business financial transaction sub-category as a categorization option.

As seen in FIGS. 3C and 3D, in accordance with one embodiment, once the user categorizes a financial transaction, such as financial transaction 337 in FIG. 3C and financial transaction 335 in FIG. 3D as a business financial transaction by selecting an uncategorized financial transaction, such as financial transaction 337 in FIG. 3C and financial transaction 335 in FIG. 3D, listed in the uncategorized financial transaction display, such as uncategorized financial transaction display 330, and making a sweeping motion to the business uncategorized financial transaction display region, such as business uncategorized financial transaction display region 336 of uncategorized financial transaction display 330, the portion of the financial transaction data representing the business financial transaction category categorized financial transaction, such as financial transaction 337 in FIG. 3C and financial transaction 335 in FIG. 3D, is processed to identify a match with a portion of the business financial transaction sub-category data representing one or more of the one or more business financial transaction sub-categories. In accordance with one embodiment, if a match is identified between the portion of the financial transaction data representing the business financial transaction category categorized financial transaction, such as financial transaction 337 in FIG. 3C and financial transaction 335 in FIG. 3D, and a portion of the business financial transaction sub-category data representing one or more of the one or more business financial transaction sub-categories, the user is automatically presented the matched business financial transaction sub-category as a categorization option. For example, with respect to financial transaction 337 in FIG. 3C, the user is automatically presented the matched business financial transaction sub-category “Travel” 343 as a categorization option. Likewise, with respect to financial transaction 335 in FIG. 3D, the user is automatically presented the matched business financial transaction sub-category “Business Income” 345 as a categorization option.

In one embodiment, if the matched business financial transaction sub-category automatically presented to the user is not desired by the user, the user can access business financial transaction category sub-category listing 351 of business financial transaction category sub-category display 350 of FIG. 3E and select the desired business financial transaction sub-category.

In one embodiment, the uncategorized financial transaction display data includes estimated tax ramifications display region data for generating an estimated tax ramifications display region within the uncategorized financial transaction display. In accordance with one embodiment, the estimated tax ramifications display region includes tax ramifications data indicating the tax ramifications associated with one or more financial transactions designated as business financial transactions. In accordance with one embodiment, once the user categorizes a financial transaction as a business financial transaction by selecting an uncategorized financial transaction listed in the uncategorized financial transaction display and making a sweeping motion to the business uncategorized financial transaction display region of the uncategorized financial transaction display, the portion of the financial transaction data representing the business financial transaction category categorized financial transaction is processed to determine the estimated tax ramifications of the business financial transaction category categorized financial transaction and the estimated tax ramifications data is updated to reflect the estimated tax ramifications associated with the business financial transaction category categorized financial transaction.

In one embodiment, once based on the selected categorization display region swept to, the data representing the selected uncategorized financial transaction is transformed from uncategorized financial transaction data to personal or business categorized financial transaction data at BASED ON THE SELECTED CATEGORIZATION DISPLAY REGION SWEPT TO, TRANSFORM THE DATA REPRESENTING THE SELECTED UNCATEGORIZED FINANCIAL TRANSACTION FROM UNCATEGORIZED FINANCIAL TRANSACTION DATA TO PERSONAL OR BUSINESS CATEGORIZED FINANCIAL TRANSACTION DATA OPERATION 313, process flow proceeds to EXIT OPERATION 315.

In one embodiment, at EXIT OPERATION 315 process 300 for providing an intuitive and interactive financial transaction categorization display is exited to await new data.

Using the embodiments of process 300 for providing an intuitive and interactive financial transaction categorization display discussed herein, users of financial management systems are provided very basic analysis, interaction, and displays showing how the user and/or business is spending money and allowing the user to easily categorize financial transactions with minimal data entry. In addition, using process 300 for providing an intuitive and interactive financial transaction categorization display, simple data reports and actions are provided that are not overly complicated and are presented to the user in a dynamic, engaging, and interactive display that provides opportunity for simple user interaction with the data and/or user modification.

Consequently, process 300 for providing an intuitive and interactive financial transaction categorization display represents a technical solution to the long standing problem in the technical fields of financial management, data display, and user experience discussed above. As a result, users of process 300 for providing an intuitive and interactive financial transaction categorization display are less likely to simply stop using the financial management system because, as noted, the process does actively engage the user while not requiring the users to devote significant time and energy to providing and/or obtaining information that is meaningful to the user.

In addition, users of process 300 for providing an intuitive and interactive financial transaction categorization display can modify, or otherwise enter data associated with specific financial transactions, such as categorization data, through a single screen and largely without the need to enter data through a keyboard, or other input device.

In addition, users of process 300 for providing an intuitive and interactive financial transaction categorization display are far less likely to lose track of which financial transactions to select and/or what categories to apply, in a “haystack” of hundreds of financial transaction categories that the user did not define.

Finally, users of process 300 for providing an intuitive and interactive financial transaction categorization display are provided displays that are both relevant and intuitive and actively engage the user in the process of analyzing and categorizing their financial transactions. Therefore the user is encouraged to become an active participant in understanding the user's financial transactions and the tax or other ramifications of those financial transactions.

In accordance with one embodiment, a method for providing an intuitive and interactive travel categorization display includes defining personal and business travel categories.

In accordance with one embodiment, travel data representing one or more trips associated with a user is obtained and the travel data is initially processed in accordance with rules data representing one or more automated categorization rules to generate a categorized portion of the travel data representing trips categorized according to the rules data as being in either the personal or business travel categories and an uncategorized portion of the travel data representing travels that are not categorized according to the rules data as being in either the personal or business travel categories.

In accordance with one embodiment, uncategorized travel display data for generating an uncategorized travel display is generated. In accordance with one embodiment, the uncategorized travel display data includes uncategorized travel listing data for generating a listing of the uncategorized trips represented by the uncategorized portion of the travel data. In one embodiment, the uncategorized travel listing data includes visual displays of the uncategorized trips such as, but not limited to, map-based representations of the uncategorized trips. In accordance with one embodiment, the uncategorized travel listing is provided in an uncategorized travel listing region of the uncategorized financial transaction display.

In accordance with one embodiment, the uncategorized travel display data includes travel categorization display regions data for defining at least two uncategorized travel display regions, a personal uncategorized travel display region and a business uncategorized travel display region. In accordance with one embodiment, the personal uncategorized travel display region is associated with the personal travel category such that when a given uncategorized trip is selected and then a sweeping motion is made towards the personal uncategorized travel display region, the given uncategorized travel is transformed into a personal travel category travel. In accordance with one embodiment, the business uncategorized travel display region is associated with the business travel category such that when a given uncategorized trip is selected and then a sweeping motion is made towards the business uncategorized travel display region, the given uncategorized travel is transformed into a business travel category travel.

In accordance with one embodiment, the uncategorized travel display data is used to generate an uncategorized travel display including an uncategorized travel listing region, a personal uncategorized travel display region, and a business uncategorized travel display region. In accordance with one embodiment, the uncategorized travel display is provided to the user on a display screen of a user computing system.

In accordance with one embodiment, the user is provided the capability to categorize each of the uncategorized trips represented by the uncategorized travel listing data of the uncategorized travel display data by selecting an uncategorized trip listed in the uncategorized travel display and making a sweeping motion to either the personal or business regions of the uncategorized travel display. In accordance with one embodiment, a selected uncategorized trip swept to the personal region of the uncategorized travel display is automatically categorized as a member of personal travel category by transforming the portion of the uncategorized travel listing data representing the uncategorized travel to personal travel category categorized travel listing data representing the formerly uncategorized travel as a personal travel category trip. Likewise, in accordance with one embodiment, a selected uncategorized trip swept to the business region of the uncategorized travel display is automatically categorized as a member of business travel category by transforming the portion of the uncategorized travel listing data representing the uncategorized travel to business travel category categorized travel listing data representing the formerly uncategorized travel as a business travel category trip.

In one embodiment, one or more personal travel sub-categories associated with the personal travel category are defined and personal travel sub-category data is generated. In accordance with one embodiment, elements of personal travel category categorized travel listing data are mapped to the personal travel category sub-categories data such that, in accordance with one embodiment, once the user categorizes a trip as personal travel by selecting an uncategorized trip listed in the uncategorized travel display and making a sweeping motion to the personal uncategorized travel display region of the uncategorized travel display, the portion of the travel data representing the personal travel category categorized trip is processed to identify a match with a portion of the personal travel sub-category data representing one or more of the one or more personal travel sub-categories. In accordance with one embodiment, if a match is identified between the portion of the travel data representing the personal travel category categorized trip and a portion of the personal travel sub-category data representing one or more of the one or more personal travel sub-categories, the user is automatically presented the matched personal travel sub-category as a categorization option.

Likewise, in one embodiment, one or more business travel sub-categories associated with the business travel category are defined and business travel sub-category data is generated. In accordance with one embodiment, elements of business travel category categorized travel listing data are mapped to the business travel category sub-categories data such that, in accordance with one embodiment, once the user categorizes travel data as a business trip by selecting an uncategorized trip listed in the uncategorized travel display and making a sweeping motion to the business uncategorized travel display region of the uncategorized travel display, the portion of the travel data representing the business travel category categorized trip is processed to identify a match with a portion of the business travel sub-category data representing one or more of the one or more business travel sub-categories. In accordance with one embodiment, if a match is identified between the portion of the travel data representing the business travel category categorized trip and a portion of the business travel sub-category data representing one or more of the one or more business travel sub-categories, the user is automatically presented the matched business travel sub-category as a categorization option.

In one embodiment, estimated tax ramifications display region data for generating an estimated tax ramifications display region within the uncategorized travel display is generated. In accordance with one embodiment, the estimated tax ramifications display region includes tax ramifications data indicating the tax ramifications associated with one or more trips designated as business travel. In accordance with one embodiment, once the user categorizes a trip as business travel by selecting an uncategorized trip listed in the uncategorized travel display and making a sweeping motion to the business uncategorized travel display region of the uncategorized travel display, the portion of the travel data representing the business travel category categorized travel is processed to determine the estimated tax ramifications of the business travel category categorized travel and the estimated tax ramifications data is updated to reflect the estimated tax ramifications associated with the business travel category categorized travel.

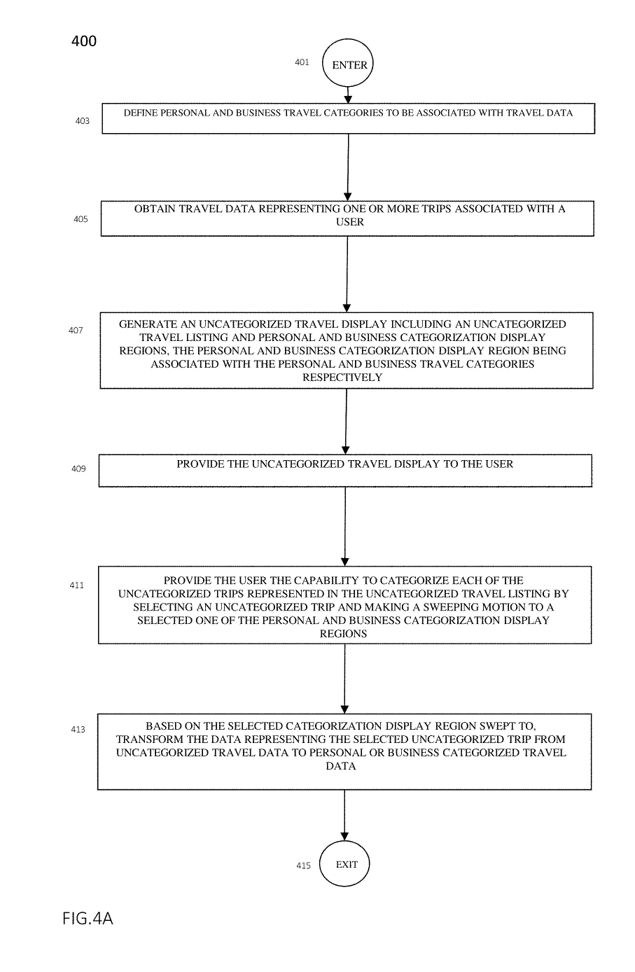

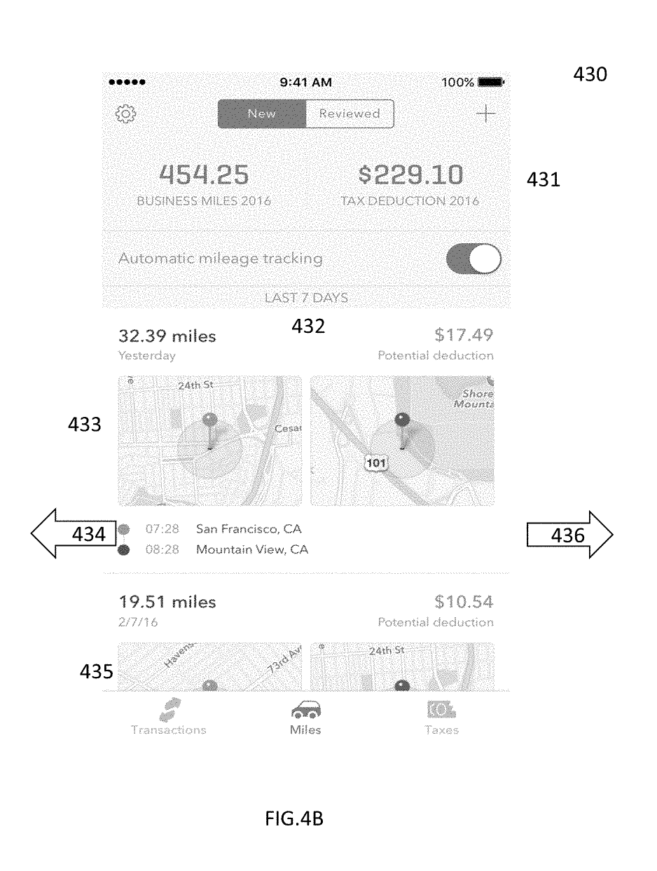

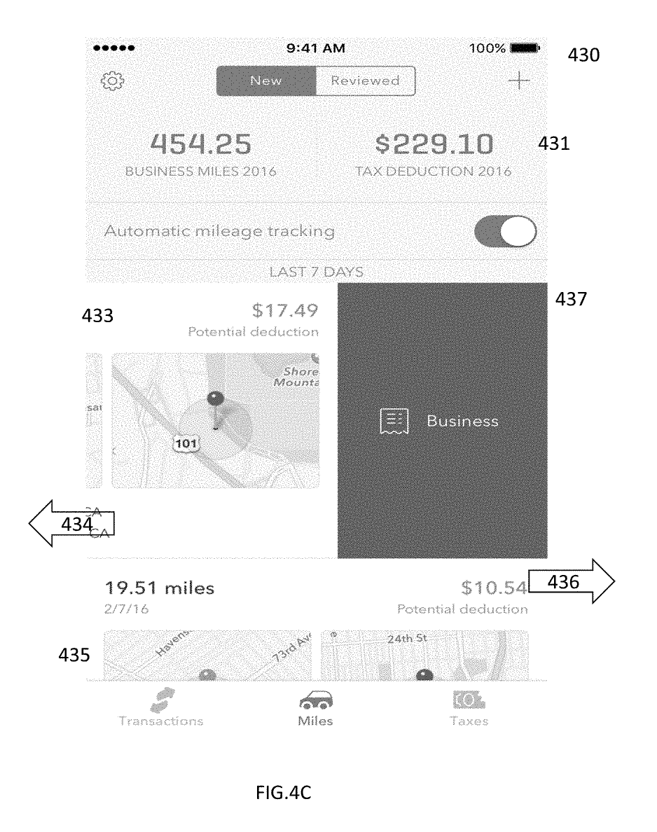

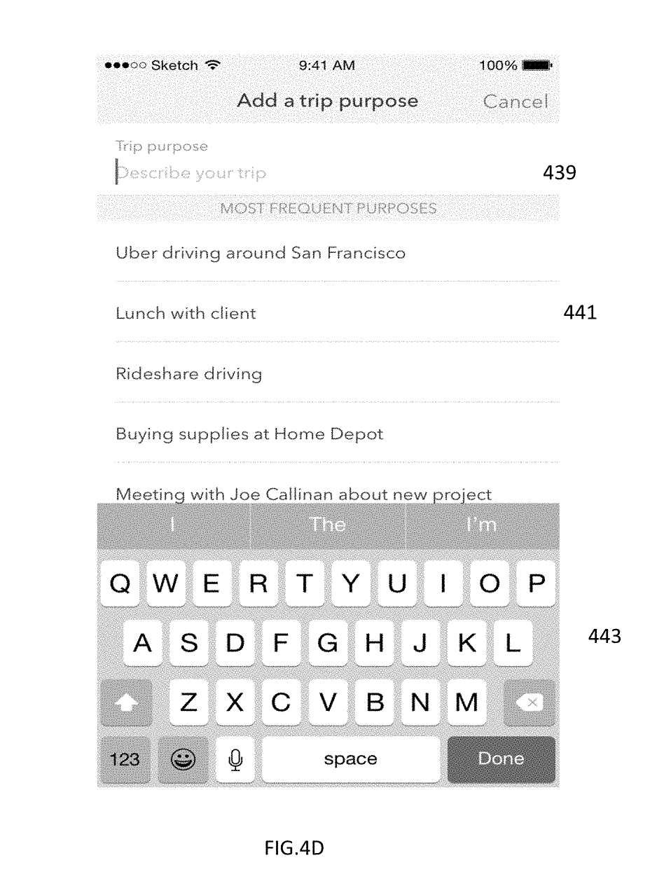

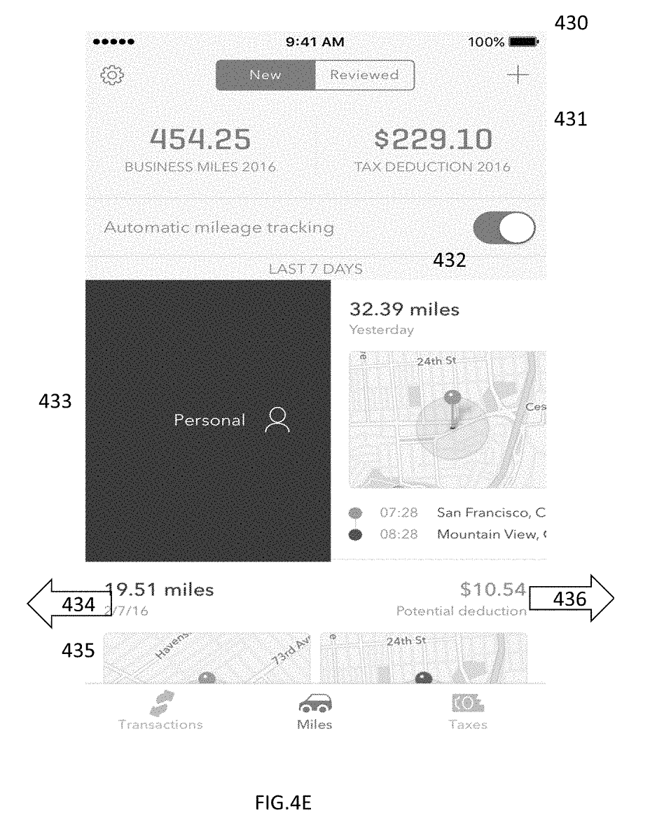

FIG. 4A is a flow chart representing one example of a process 400 for providing an intuitive and interactive travel categorization display in accordance with one embodiment. FIGS. 4B, 4C, 4D, and 4E, represent specific illustrative examples of display screens associated with process 400 for providing an intuitive and interactive travel categorization display in accordance with one embodiment.

Referring to FIGS. 4A, 4B, 4C, 4D, and 4E together, process 400 for providing an intuitive and interactive travel categorization display begins at ENTER OPERATION 401 and process flow proceeds to DEFINE PERSONAL AND BUSINESS TRAVEL CATEGORIES TO BE ASSOCIATED WITH TRAVEL DATA OPERATION 403.

In one embodiment, at DEFINE PERSONAL AND BUSINESS TRAVEL CATEGORIES TO BE ASSOCIATED WITH TRAVEL DATA OPERATION 403 personal and business travel categories to be applied to, or otherwise associated with, one or more trips represented in travel data are defined.

In one embodiment, once personal and business travel categories to be applied to, or otherwise associated with, one or more trips represented in travel data are defined and travel category data representing the defined travel categories are generated at DEFINE PERSONAL AND BUSINESS TRAVEL CATEGORIES TO BE ASSOCIATED WITH TRAVEL DATA OPERATION 403, process flow proceeds to OBTAIN TRAVEL DATA REPRESENTING ONE OR MORE TRIPS ASSOCIATED WITH A USER OPERATION 405.

In one embodiment, at OBTAIN TRAVEL DATA REPRESENTING ONE OR MORE TRIPS ASSOCIATED WITH A USER OPERATION 405, travel data is obtained from one or more financial management systems and/or other travel data sources, such as any of the financial management systems and/or other travel data sources discussed herein, and/or as known in the art at the time of filing, and/or as developed after the time of filing, and/or by any means as discussed herein, and/or as known in the art at the time of filing, and/or as becomes known after the time of filing.

In one embodiment, the travel data is travel data from a defined relevant period of time such as, a day, a week, a month, quarter, a year, etc. In various embodiments the relevant period of time is defined by the user, and/or provider, of the method and system for providing an intuitive and interactive travel categorization display.

In one embodiment, the travel data is presented as maps of recent trips conducted by the user and recorded using one or more travel trackers implemented on a user computing system.

In one embodiment, once the travel data is obtained, the travel data is subjected to an initial processing whereby the travel data is analyzed with rules data representing one or more automated initial categorization rules.

In various embodiments, the one or more automated initial categorization rules represented by the rules data is generated by/obtained from one or more of the provider of the method and system for providing an intuitive and interactive travel categorization display, the user, and/or one or more financial management systems. In one embodiment, the one or more automated initial categorization rules represented by the rules data is generated by, and/or updated, based on historical categorizations of travel/trips by the user so that the one or more automated initial categorization rules are continuously updated based on actions taken by the user and customized to the user.

In one embodiment, as a result of the travel data being initially processed in accordance with rules data representing one or more automated categorization rules, some of the travel/trips represented by part of the travel data are categorized automatically as the travel data is received. Consequently, as a result of the travel data being initially processed in accordance with rules data, a categorized portion of the travel data is transformed into initially categorized travel data representing travel/trips categorized according to the rules data as being in either the personal or business travel categories. Likewise, an uncategorized portion of the travel data representing travel/trips that are not categorized according to the rules data as being in either the personal or business travel categories is also generated/defined.

In one embodiment, once travel data is obtained from one or more financial management systems and/or other travel data sources at OBTAIN TRAVEL DATA REPRESENTING ONE OR MORE TRIPS ASSOCIATED WITH A USER OPERATION 405, process flow proceeds to GENERATE AN UNCATEGORIZED TRAVEL DISPLAY INCLUDING AN UNCATEGORIZED TRAVEL LISTING AND PERSONAL AND BUSINESS CATEGORIZATION DISPLAY REGIONS, THE PERSONAL AND BUSINESS CATEGORIZATION DISPLAY REGION BEING ASSOCIATED WITH THE PERSONAL AND BUSINESS TRAVEL CATEGORIES RESPECTIVELY OPERATION 407.

In one embodiment, at GENERATE AN UNCATEGORIZED TRAVEL DISPLAY INCLUDING AN UNCATEGORIZED TRAVEL LISTING AND PERSONAL AND BUSINESS CATEGORIZATION DISPLAY REGIONS, THE PERSONAL AND BUSINESS CATEGORIZATION DISPLAY REGION BEING ASSOCIATED WITH THE PERSONAL AND BUSINESS TRAVEL CATEGORIES RESPECTIVELY OPERATION 407, uncategorized travel display data for generating an uncategorized travel display is generated.

In one embodiment, the intuitive and interactive travel categorization display generated by the uncategorized travel display data includes an uncategorized travel listing region including a listing of the uncategorized travel/trips represented by the uncategorized portion of the travel data. As noted above, in one embodiment, the listing of the uncategorized travel/trips represented by the uncategorized portion of the travel data is presented in the form of maps representing the uncategorized trips. Consequently, in accordance with one embodiment, the uncategorized travel display data includes uncategorized travel listing data for generating a listing of the uncategorized travel/trips represented by the uncategorized portion of the travel data in the uncategorized travel listing region of the uncategorized travel display.

In one embodiment, the uncategorized travel listing region of the intuitive and interactive travel categorization display includes an uncategorized travel listing displaying the individual uncategorized travel/trips not yet mapped to either the personal or business travel categories. In one embodiment, the uncategorized travel listing region is positioned approximately halfway between the personal and business uncategorized travel display regions discussed below.

As seen in FIGS. 4B, 4C, and 4E, in one embodiment, intuitive and interactive travel categorization display 430 generated by the uncategorized travel display data includes an uncategorized travel listing region 432 including a listing of the uncategorized travel/trips 433 and 435 represented by the uncategorized portion of the travel data. As seen in FIGS. 4B, 4C, and 4E, the listing of the uncategorized travel/trips represented by the uncategorized portion of the travel data is presented in the form of maps representing the uncategorized trips.

In accordance with one embodiment, the uncategorized travel display includes at least two uncategorized travel display regions, or directions: a personal uncategorized travel display region/direction and a business uncategorized travel display region/direction. Consequently, in one embodiment, the uncategorized travel display data includes travel categorization display regions data for defining the personal and business uncategorized travel display regions/directions.

As seen in FIGS. 4B, 4C, and 4E in accordance with one embodiment, travel categorization display 430 includes at least two uncategorized travel display regions, or directions: personal uncategorized travel display region/direction 434 and business uncategorized travel display region/direction 436. Consequently, in one embodiment, the uncategorized travel display data includes travel categorization display regions data for defining the personal and business uncategorized travel display regions/directions.

In accordance with one embodiment, the personal uncategorized travel display region is associated with the personal travel category such that when a given uncategorized trip, or portion of a given uncategorized trip, is selected and then a sweeping motion is made by the user towards the personal uncategorized travel display region/direction, the given uncategorized trip, or portion of a given uncategorized trip, is transformed into a personal travel category trip. In accordance with one embodiment, the business uncategorized travel display region is associated with the business travel category such that when a given uncategorized trip, or portion of a given uncategorized trip, is selected and then a sweeping motion is made towards the business uncategorized travel display region/direction, the given uncategorized trip, or portion of a given uncategorized trip, is transformed into a business travel category trip.

In various embodiments, the personal and business uncategorized travel display regions/directions are visually distinguishable from each other and represented as physically removed from one another. For instance, as a specific illustrative example, in one embodiment, the personal display region of the uncategorized travel display is associated with a first color and is displayed in a personal display region on a first side of the uncategorized travel display, while the business display region of the uncategorized travel display is of a second color and is displayed in a business display region on a second side of the uncategorized travel display.

In various other embodiments, the personal display region of the uncategorized travel display is associated with any graphic of any color and is displayed in a personal display region in any region of the intuitive and interactive travel categorization display, while the business display region of the uncategorized travel display is associated with any graphic of any color and is displayed in a business display region in any different region of the intuitive and interactive travel categorization display.

In accordance with one embodiment, the uncategorized travel display data is used to generate an uncategorized travel display including an uncategorized travel listing region, a personal uncategorized travel display region, and a business uncategorized travel display region.

In one embodiment, once uncategorized travel display data for generating an uncategorized travel display is generated at GENERATE AN UNCATEGORIZED TRAVEL DISPLAY INCLUDING AN UNCATEGORIZED TRAVEL LISTING AND PERSONAL AND BUSINESS CATEGORIZATION DISPLAY REGIONS, THE PERSONAL AND BUSINESS CATEGORIZATION DISPLAY REGION BEING ASSOCIATED WITH THE PERSONAL AND BUSINESS TRAVEL CATEGORIES RESPECTIVELY OPERATION 407, process flow proceeds to PROVIDE THE UNCATEGORIZED TRAVEL DISPLAY TO THE USER OPERATION 409.

In one embodiment, at PROVIDE THE UNCATEGORIZED TRAVEL DISPLAY TO THE USER OPERATION 409, once the intuitive and interactive travel categorization display is generated, the intuitive and interactive travel categorization display is provided to the user on a display screen of a user computing system owed, accessible by, or otherwise associated with, the user.

In various embodiments, the user computing system is any computing system as discussed herein, and/or as known in the art at the time of filing, and/or as developed after the time of filing.

In various embodiments, the display screen of the user computing system is a touch screen, or other interactive display screen capable of receiving user input via touch, stylus, or other user input device or mechanism, as discussed herein, and/or as known in the art at the time of filing, and/or as developed after the time of filing.

In one embodiment, once the intuitive and interactive travel categorization display is provided to the user on a display screen of a user computing system owed, accessible by, or otherwise associated with, the user at PROVIDE THE UNCATEGORIZED TRAVEL DISPLAY TO THE USER OPERATION 409, process flow proceeds to PROVIDE THE USER THE CAPABILITY TO CATEGORIZE EACH OF THE UNCATEGORIZED TRIPS REPRESENTED IN THE UNCATEGORIZED TRAVEL LISTING BY SELECTING AN UNCATEGORIZED TRIP AND MAKING A SWEEPING MOTION TO A SELECTED ONE OF THE PERSONAL AND BUSINESS CATEGORIZATION DISPLAY REGIONS OPERATION 411

In one embodiment, at PROVIDE THE USER THE CAPABILITY TO CATEGORIZE EACH OF THE UNCATEGORIZED TRIPS REPRESENTED IN THE UNCATEGORIZED TRAVEL LISTING BY SELECTING AN UNCATEGORIZED TRIP AND MAKING A SWEEPING MOTION TO A SELECTED ONE OF THE PERSONAL AND BUSINESS CATEGORIZATION DISPLAY REGIONS OPERATION 411, the user is provided the opportunity to dynamically and intuitively categorize each of the uncategorized travel/trips in either the personal travel category or the business travel category.

In accordance with one embodiment, the user is provided the capability to categorize each of the uncategorized travel/trips represented by the uncategorized travel listing data of the uncategorized travel display data by selecting an uncategorized trip listed in the uncategorized travel display and making a sweeping motion to, or in the direction of, either the first or second region of the uncategorized travel display.

In one embodiment, once the user is provided the opportunity to dynamically and intuitively categorize each of the uncategorized travel/trips in either the personal travel category or the business travel category at PROVIDE THE USER THE CAPABILITY TO CATEGORIZE EACH OF THE UNCATEGORIZED TRIPS REPRESENTED IN THE UNCATEGORIZED TRAVEL LISTING BY SELECTING AN UNCATEGORIZED TRIP AND MAKING A SWEEPING MOTION TO A SELECTED ONE OF THE PERSONAL AND BUSINESS CATEGORIZATION DISPLAY REGIONS OPERATION 411, process flow proceeds to BASED ON THE SELECTED CATEGORIZATION DISPLAY REGION SWEPT TO, TRANSFORM THE DATA REPRESENTING THE SELECTED UNCATEGORIZED TRIP FROM UNCATEGORIZED TRAVEL DATA TO PERSONAL OR BUSINESS CATEGORIZED TRAVEL DATA OPERATION 413.

In one embodiment, at BASED ON THE SELECTED CATEGORIZATION DISPLAY REGION SWEPT TO, TRANSFORM THE DATA REPRESENTING THE SELECTED UNCATEGORIZED TRIP FROM UNCATEGORIZED TRAVEL DATA TO PERSONAL OR BUSINESS CATEGORIZED TRAVEL DATA OPERATION 413, based on the selected categorization display region swept to, the data representing the selected uncategorized trip from uncategorized travel data is transformed to personal or business categorized travel data.

In one embodiment, a selected uncategorized trip swept to the personal region of the uncategorized travel display is automatically categorized as a member of personal travel category by transforming the portion of the uncategorized travel listing data representing the uncategorized travel to personal travel category categorized travel listing data representing the formerly uncategorized travel as a personal travel category trip.

Likewise, in accordance with one embodiment, a selected uncategorized travel swept to the business region of the uncategorized travel display is automatically categorized as a member of business travel category by transforming the portion of the uncategorized travel listing data representing the uncategorized travel to business travel category categorized travel listing data representing the formerly uncategorized travel as a business trip category travel.

Consequently, using the method and system for providing an intuitive and interactive travel categorization display, personal trips/travel and business trips/travel can be designated, determined, and displayed in an engaging and “game-like” manner via a simple user interaction motion, such as, but not limited to, a single sweeping action of the user's finger towards the first uncategorized travel region of the disclosed interactive uncategorized travel display or the second uncategorized travel region spending display region of the disclosed interactive uncategorized travel display.

As seen in FIG. 4E, in accordance with one embodiment, personal uncategorized travel display region/direction 434 is associated with the personal travel category such that when a given uncategorized trip, or portion of a given uncategorized trip, such as uncategorized travel/trip 433 in FIG. 4B is selected and then a sweeping motion is made by the user towards personal uncategorized travel display region/direction 434, the given uncategorized trip, or portion of a given uncategorized trip, such as uncategorized travel/trip 433 in FIG. 4B is transformed into a personal travel category trip in FIG. 4E.

Likewise, as seen in FIG. 4C, in accordance with one embodiment, business uncategorized travel display region/direction 436 is associated with the business travel category such that when a given uncategorized trip, or portion of a given uncategorized trip, such as uncategorized travel/trip 433 in FIG. 4B is selected and then a sweeping motion is made by the user towards business uncategorized travel display region/direction 436, the given uncategorized trip, or portion of a given uncategorized trip, such as uncategorized travel/trip 433 in FIG. 4B is transformed into a business travel category trip in FIG. 4C.

In one embodiment, one or more travel sub-categories associated with the personal and business travel categories are defined and personal and business travel category sub-categories data is generated.

In accordance with one embodiment, elements of personal and business travel category categorized travel listing data are mapped to the personal and business travel category sub-categories data such that, in accordance with one embodiment, once the user categorizes a trip as personal travel by selecting an uncategorized trip listed in the uncategorized travel display and making a sweeping motion to the personal uncategorized travel display region of the uncategorized travel display, the portion of the travel data representing the personal travel category categorized travel is processed to identify a match with a portion of the personal travel sub-category data representing one or more of the one or more personal travel sub-categories. In accordance with one embodiment, if a match is identified between the portion of the travel data representing the personal travel category categorized travel and a portion of the personal travel sub-category data representing one or more of the one or more personal travel sub-categories, the user is automatically presented the matched personal travel sub-category as a categorization option.

Likewise, in accordance with one embodiment, once the user categorizes a trip as a business trip by selecting an uncategorized trip listed in the uncategorized travel display and making a sweeping motion to the business uncategorized travel display region of the uncategorized travel display, the portion of the travel data representing the business travel category categorized trip is processed to identify a match with a portion of the business travel sub-category data representing one or more of the one or more business travel sub-categories. In accordance with one embodiment, if a match is identified between the portion of the travel data representing the business travel category categorized trip and a portion of the business travel sub-category data representing one or more of the one or more business travel sub-categories, the user is automatically presented the matched business travel sub-category as a categorization option.

In one embodiment, the user is provided the capability to add notes and/or customize/modify a travel sub-category. In one embodiment, this is preformed via a notes and customization display.

FIG. 4D shows one illustrative example of a notes and customization display 439 including a listing of notes and customization entry recommendations 441 and a data entry interface 443.

In one embodiment, the uncategorized travel display data includes estimated tax ramifications display region data for generating an estimated tax ramifications display region within the uncategorized travel display. In accordance with one embodiment, the estimated tax ramifications display region includes tax ramifications data indicating the tax ramifications associated with one or more travel/trips designated as business travel/trips. In accordance with one embodiment, once the user categorizes a trip as a business trip by selecting an uncategorized trip listed in the uncategorized travel display and making a sweeping motion to the business uncategorized travel display region of the uncategorized travel display, the portion of the travel data representing the business travel category categorized travel is processed to determine the estimated tax ramifications of the business travel category categorized travel and the estimated tax ramifications data is updated to reflect the estimated tax ramifications associated with the business travel category categorized travel.

As seen in FIGS. 4B, 4C and 4E in one embodiment, travel categorization display 430 includes estimated tax ramifications display region 431 within the uncategorized travel listing region 432. In accordance with one embodiment, estimated tax ramifications display region 431 includes tax ramifications data indicating the tax ramifications associated with one or more travel/trips designated as business travel/trips. In accordance with one embodiment, once the user categorizes a trip as a business trip by selecting an uncategorized trip listed in the uncategorized travel display and making a sweeping motion to the business uncategorized travel display region of the uncategorized travel display, the portion of the travel data representing the business travel category categorized travel is processed to determine the estimated tax ramifications of the business travel category categorized travel and the estimated tax ramifications data is updated to reflect the estimated tax ramifications associated with the business travel category categorized travel in estimated tax ramifications display region 431

In one embodiment, once based on the selected categorization display region swept to, the data representing the selected uncategorized trip is transformed from uncategorized travel data to personal or business categorized travel data at BASED ON THE SELECTED CATEGORIZATION DISPLAY REGION SWEPT TO, TRANSFORM THE DATA REPRESENTING THE SELECTED UNCATEGORIZED TRIP FROM UNCATEGORIZED TRAVEL DATA TO PERSONAL OR BUSINESS CATEGORIZED TRAVEL DATA OPERATION 413, process flow proceeds to EXIT OPERATION 415.

In one embodiment, at EXIT OPERATION 415 process 400 for providing an intuitive and interactive travel categorization display is exited to await new data.

Using process 400 for providing an intuitive and interactive travel categorization display, users of financial management systems are provided very basic analysis, interaction, and displays showing how the user and/or business travel is impacting the business and allowing the user to easily categorize travel with minimal data entry. In addition, using process 400 for providing an intuitive and interactive travel categorization display, simple data reports and actions are provided that are not overly complicated and are presented to the user in a dynamic, engaging, and interactive display that provides opportunity for simple user interaction with the data and/or user modification.

Consequently, process 400 for providing an intuitive and interactive travel categorization display represents a technical solution to the long standing problem in the technical fields of financial management, data display, and user experience discussed above. As a result, users of the embodiments discussed herein are less likely to simply stop using the financial management system because, as noted, the process does actively engage the user while not requiring the users to devote significant time and energy to providing and/or obtaining information that is meaningful to the user.

In addition, users of process 400 for providing an intuitive and interactive travel categorization display can modify, or otherwise enter data associated with specific travel and trips, such as categorization data, through a single screen and largely without the need to enter data through a keyboard, or other input device.

In addition, users of process 400 for providing an intuitive and interactive travel categorization display are provided displays that are both relevant and intuitive and actively engage the user in the process of analyzing and categorizing their travel. Therefore the user is encouraged to become an active participant in understanding the user's travel and the tax or other ramifications of that travel.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “accessing,” “analyzing,” “obtaining,” “identifying,” “associating,” “aggregating,” “initiating,” “collecting,” “creating,” “transferring,” “storing,” “searching,” “comparing,” “providing,” “processing” etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes by a computer program stored via a computer program product as defined herein that can be accessed by a computing system or other device to transform the computing system or other device into a specifically and specially programmed computing system or other device.

Those of skill in the art will readily recognize that the algorithms and operations presented herein are not inherently related to any particular computing system, computer architecture, computer or industry standard, or any other specific apparatus. It may prove convenient/efficient to construct or transform one or more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity, and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGs. are identified using a particular nomenclature for ease of description and understanding, but other nomenclature is often used in the art to identify equivalent operations.

In the discussion above, certain aspects of one embodiment include process steps and/or operations and/or instructions described herein for illustrative purposes in a particular order and/or grouping. However, the particular order and/or grouping shown and discussed herein is illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein does not limit the scope of the invention as claimed below.

Therefore, numerous variations, whether explicitly provided for by the specification or implied by the specification or not, may be implemented by one of skill in the art in view of this disclosure.

What is claimed is:

1. A method for providing an intuitive and interactive financial transaction categorization display comprising:
defining first and second financial transaction categories;
obtaining financial transaction data representing one or more financial transactions associated with a user;
processing the financial transaction data in accordance with rules data representing one or more automated categorization rules to generate a categorized portion of the financial transaction data representing financial transactions categorized according to the rules data as being in either the first or second financial transaction categories and an uncategorized portion of the financial transaction data representing financial transactions that are not categorized according to the rules data as being in either the first or second financial transaction categories;
generating uncategorized financial transaction display data for generating an uncategorized financial transaction display, the uncategorized financial transaction display data including uncategorized financial transaction listing data for generating a listing of the uncategorized financial transactions represented by the uncategorized portion of the financial transaction data, the uncategorized financial transaction display data also including categorization display regions data for defining at least two uncategorized financial transaction display regions, a first uncategorized financial transaction display region being associated with the first financial transaction category and a second uncategorized financial transaction display region being associated with the second financial transaction category;
using the uncategorized financial transaction display data to generate an uncategorized financial transaction display and providing the uncategorized financial transaction display to the user on a display screen of a user computing system;
providing the user the capability to categorize each of the uncategorized financial transactions represented by the uncategorized financial transaction listing data of the uncategorized financial transaction display data by selecting an uncategorized financial transaction listed in the uncategorized financial transaction display and making a sweeping motion to either the first or second region of the uncategorized financial transaction display,
wherein a selected uncategorized financial transaction swept to the first region of the uncategorized financial transaction display is automatically categorized as a member of first financial transaction category by transforming the portion of the uncategorized financial transaction listing data representing the uncategorized financial transaction to first financial transaction category categorized financial transaction listing data representing the formerly uncategorized financial transaction as a first financial transaction category financial transaction,
further wherein a selected uncategorized financial transaction swept to the second region of the uncategorized financial transaction display is automatically categorized as a member of second financial transaction category by transforming the portion of the uncategorized financial transaction listing data representing the uncategorized financial transaction to second financial transaction category categorized financial transaction listing data representing the formerly uncategorized financial transaction as a second financial transaction category financial transaction.

2. The method for providing an intuitive and interactive financial transaction categorization display of claim 1 wherein the financial transaction data representing one or more financial transactions associated with a user is obtained from a financial management system selected from the group of financial management systems consisting of:
a computing system implemented financial management system;
a network accessed financial management system;
a web-based financial management system; and
a cloud-based financial management system.

3. The method for providing an intuitive and interactive financial transaction categorization display of claim 1 wherein the one or more financial transactions are categorized by a financial management system selected from the group of financial management systems consisting of:
a computing system implemented financial management system;
a network accessed financial management system;
a web-based financial management system; and
a cloud-based financial management system.

4. The method for providing an intuitive and interactive financial transaction categorization display of claim 1 wherein the first and second financial transaction categories are selected from the group of first and second financial transaction category pairs consisting of;
a personal and business expense financial transaction category pair;
a personal and business travel financial transaction category pair;
a discretionary and non-discretionary financial transaction category pair.

5. The method for providing an intuitive and interactive financial transaction categorization display of claim 1 wherein the first uncategorized financial transaction display region and the second uncategorized financial transaction display region are associated with a first uncategorized financial transaction display region graphic and a second uncategorized financial transaction display region graphic selected from the group of uncategorized financial transaction display region graphics consisting of:
a first uncategorized financial transaction display region graphic color associated the first uncategorized financial transaction display region and a second uncategorized financial transaction display region graphic color associated with the second uncategorized financial transaction display region;
a first color uncategorized financial transaction display region pop-up graphic associated the first uncategorized financial transaction display region and a second color uncategorized financial transaction display region pop-up graphic associated with the second uncategorized financial transaction display region;
a first uncategorized financial transaction display region icon graphic associated the first uncategorized financial transaction display region and a second uncategorized financial transaction display region icon graphic associated with the second uncategorized financial transaction display region;
a first uncategorized financial transaction display region animated graphic associated the first uncategorized financial transaction display region and a second uncategorized financial transaction display region animated graphic associated with the second uncategorized financial transaction display region;
a first uncategorized financial transaction display region shaped graphic associated the first uncategorized financial transaction display region and a second uncategorized financial transaction display region shaped graphic associated with the second uncategorized financial transaction display region;
a first uncategorized financial transaction display region symbol graphic associated the first uncategorized financial transaction display region and a second uncategorized financial transaction display region symbol graphic associated with the second uncategorized financial transaction display region;
a first uncategorized financial transaction display region alpha-numeric graphic associated the first uncategorized financial transaction display region and a second uncategorized financial transaction display region alpha-numeric graphic associated with the second uncategorized financial transaction display region; and
a first uncategorized financial transaction display region avatar graphic associated the first uncategorized financial transaction display region and a second uncategorized financial transaction display region avatar graphic associated with the second uncategorized financial transaction display region.

6. The method for providing an intuitive and interactive financial transaction categorization display of claim 1 wherein providing the user the capability to categorize each of the uncategorized financial transactions represented by the uncategorized financial transaction listing data of the uncategorized financial transaction display data by selecting an uncategorized financial transaction listed in the uncategorized financial transaction display and making a sweeping motion to either the first or second region of the uncategorized financial transaction display is performed via a single sweeping motion by the user on the display device of the user computing system.

7. The method for providing an intuitive and interactive financial transaction categorization display of claim 6 wherein the single sweeping motion by the user on the display device of the user computing system is performed via the user's finger.

8. A method for providing an intuitive and interactive financial transaction categorization display comprising:
defining personal and business financial transaction categories;
obtaining financial transaction data representing one or more financial transactions associated with a user;
processing the financial transaction data in accordance with rules data representing one or more automated categorization rules to generate a categorized portion of the financial transaction data representing financial transactions categorized according to the rules data as being in either the personal or business financial transaction categories and an uncategorized portion of the financial transaction data representing financial transactions that are not categorized according to the rules data as being in either the personal or business financial transaction categories;
generating uncategorized financial transaction display data for generating an uncategorized financial transaction display, the uncategorized financial transaction display data including uncategorized financial transaction listing data for generating a listing of the uncategorized financial transactions represented by the uncategorized portion of the financial transaction data, the uncategorized financial transaction display data also including personal and business categorization display regions data for defining personal or business uncategorized financial transaction display regions within the uncategorized financial transaction display, the personal uncategorized financial transaction display region being associated with the personal financial transaction category and the business uncategorized financial transaction display region being associated with the business financial transaction category;
using the uncategorized financial transaction display data to generate and provide an uncategorized financial transaction display to the user on a display screen of a user computing system;
providing the user the capability to categorize each of the uncategorized financial transactions represented by the uncategorized financial transaction listing data of the uncategorized financial transaction display data as either a personal or business financial transaction by selecting an uncategorized financial transaction listed in the uncategorized financial transaction display and making a sweeping motion to either the personal or business uncategorized financial transaction display regions of the uncategorized financial transaction display;
wherein a selected uncategorized financial transaction swept to the personal region of the uncategorized financial transaction display is automatically categorized as a personal related financial transaction by transforming the portion of the uncategorized financial transaction listing data representing the uncategorized financial transaction to personal financial transaction category categorized financial transaction listing data representing the formerly uncategorized financial transaction as a personal financial transaction category financial transaction;
further wherein a selected uncategorized financial transaction swept to the business region of the uncategorized financial transaction display is automatically categorized as a business related financial transaction by transforming the portion of the uncategorized financial transaction listing data representing the uncategorized financial transaction to business financial transaction category categorized financial transaction listing data representing the formerly uncategorized financial transaction as a business financial transaction category financial transaction.

9. The method for providing an intuitive and interactive financial transaction categorization display of claim 8 wherein the financial transaction data representing one or more financial transactions associated with a user is obtained from a financial management system selected from the group of financial management systems consisting of:
a computing system implemented financial management system;
a network accessed financial management system;
a web-based financial management system; and
a cloud-based financial management system.

10. The method for providing an intuitive and interactive financial transaction categorization display of claim 8 wherein the one or more financial transactions are categorized by a financial management system selected from the group of financial management systems consisting of:
a computing system implemented financial management system;
a network accessed financial management system;
a web-based financial management system; and
a cloud-based financial management system.

11. The method for providing an intuitive and interactive financial transaction categorization display of claim 8 wherein,
the personal uncategorized financial transaction display region and the business uncategorized financial transaction display region are associated with a personal uncategorized financial transaction display region graphic and a business uncategorized financial transaction display region graphic selected from the group of uncategorized financial transaction display region graphics consisting of:
a personal uncategorized financial transaction display region graphic color associated the personal uncategorized financial transaction display region and a business uncategorized financial transaction display region graphic color associated with the business uncategorized financial transaction display region;
a first color uncategorized financial transaction display region pop-up graphic associated the personal uncategorized financial transaction display region and a second color uncategorized financial transaction display region pop-up graphic associated with the business uncategorized financial transaction display region;
a personal uncategorized financial transaction display region icon graphic associated the personal uncategorized financial transaction display region and a business uncategorized financial transaction display region icon graphic associated with the business uncategorized financial transaction display region;
a personal uncategorized financial transaction display region animated graphic associated the personal uncategorized financial transaction display region and a business uncategorized financial transaction display region animated graphic associated with the business uncategorized financial transaction display region;
a personal uncategorized financial transaction display region shaped graphic associated the personal uncategorized financial transaction display region and a business uncategorized financial transaction display region shaped graphic associated with the business uncategorized financial transaction display region;
a personal uncategorized financial transaction display region symbol graphic associated the personal uncategorized financial transaction display region and a business uncategorized financial transaction display region symbol graphic associated with the business uncategorized financial transaction display region;
a personal uncategorized financial transaction display region alpha-numeric graphic associated the personal uncategorized financial transaction display region and a business uncategorized financial transaction display region alpha-numeric graphic associated with the business uncategorized financial transaction display region; and
a personal uncategorized financial transaction display region avatar graphic associated the personal uncategorized financial transaction display region and a business uncategorized financial transaction display region avatar graphic associated with the business uncategorized financial transaction display region.

12. The method for providing an intuitive and interactive financial transaction categorization display of claim 8 wherein providing the user the capability to categorize each of the uncategorized financial transactions represented by the uncategorized financial transaction listing data of the uncategorized financial transaction display data by selecting an uncategorized financial transaction listed in the uncategorized financial transaction display and making a sweeping motion to either the personal or business region of the uncategorized financial transaction display is performed via a single sweeping motion by the user on the display device of the user computing system.

13. The method for providing an intuitive and interactive financial transaction categorization display of claim 12 wherein the single sweeping motion by the user on the display device of the user computing system is performed via the user's finger.

14. The method for providing an intuitive and interactive financial transaction categorization display of claim 8 further comprising:
defining one or more personal financial transaction sub-categories associated with the personal financial transaction category and generating personal financial transaction sub-category data;
mapping elements of personal financial transaction category categorized financial transaction listing data to personal financial transaction sub-category data representing one or more of the one or more personal financial transaction sub-categories;
wherein once the user categorizes a financial transaction as a personal financial transaction by selecting an uncategorized financial transaction listed in the uncategorized financial transaction display and making a sweeping motion to the personal uncategorized financial transaction display region of the uncategorized financial transaction display, the portion of the financial transaction data representing the personal financial transaction category categorized financial transaction is processed to identify a match with a portion of the personal financial transaction sub-category data representing one or more of the one or more personal financial transaction sub-categories;
further wherein if a match is identified between the portion of the financial transaction data representing the personal financial transaction category categorized financial transaction and a portion of the personal financial transaction sub-category data representing one or more of the one or more personal financial transaction sub-categories, the user is presented the matched personal financial transaction sub-category as a categorization option.

15. The method for providing an intuitive and interactive financial transaction categorization display of claim 8 further comprising:
defining one or more personal financial transaction sub-categories associated with the personal financial transaction category and generating personal financial transaction sub-category data wherein,
once the user categorizes a financial transaction as a personal financial transaction by selecting an uncategorized financial transaction listed in the uncategorized financial transaction display and making a sweeping motion to the personal uncategorized financial transaction display region of the uncategorized financial transaction display, the user is presented the personal financial transaction sub-categories represented by the personal financial transaction sub-category data as categorization options.

16. The method for providing an intuitive and interactive financial transaction categorization display of claim 8 further comprising:
defining one or more business financial transaction sub-categories associated with the business financial transaction category and generating business financial transaction sub-category data;
mapping elements of business financial transaction category categorized financial transaction listing data to business financial transaction sub-category data representing one or more of the one or more business financial transaction sub-categories, wherein,
once the user categorizes a financial transaction as a business financial transaction by selecting an uncategorized financial transaction listed in the uncategorized financial transaction display and making a sweeping motion to the business uncategorized financial transaction display region of the uncategorized financial transaction display, the portion of the financial transaction data representing the business financial transaction category categorized financial transaction is processed to identify a match with a portion of the business financial transaction sub-category data representing one or more of the one or more business financial transaction sub-categories, further wherein,
if a match is identified between the portion of the financial transaction data representing the business financial transaction category categorized financial transaction and a portion of the business financial transaction sub-category data representing one or more of the one or more business financial transaction sub-categories, the user is presented the matched business financial transaction sub-category as a categorization option.

17. The method for providing an intuitive and interactive financial transaction categorization display of claim 8 further comprising:
defining one or more business financial transaction sub-categories associated with the business financial transaction category and generating business financial transaction sub-category data;
wherein once the user categorizes a financial transaction as a business financial transaction by selecting an uncategorized financial transaction listed in the uncategorized financial transaction display and making a sweeping motion to the business uncategorized financial transaction display region of the uncategorized financial transaction display, the user is presented the business financial transaction sub-categories represented by the business financial transaction sub-category data as categorization options.

18. The method for providing an intuitive and interactive financial transaction categorization display of claim 8 further comprising:
estimated tax ramifications display region data for generating an estimated tax ramifications display region within the uncategorized financial transaction display, the estimated tax ramifications display region including tax ramifications data indicating the tax ramifications associated with one or more financial transactions designated as business financial transactions.

19. The method for providing an intuitive and interactive financial transaction categorization display of claim 18 wherein, once the user categorizes a financial transaction as a business financial transaction by selecting an uncategorized financial transaction listed in the uncategorized financial transaction display and making a sweeping motion to the business uncategorized financial transaction display region of the uncategorized financial transaction display, the portion of the financial transaction data representing the business financial transaction category categorized financial transaction is processed to determine the estimated tax ramifications of the business financial transaction category categorized financial transaction and the estimated tax ramifications data is updated to reflect the estimated tax ramifications associated with the business financial transaction category categorized financial transaction.

20. The method for providing an intuitive and interactive financial transaction categorization display of claim 19 wherein the estimated tax ramifications display region data generates an estimated tax ramifications display region within the uncategorized financial transaction display that includes data indicating the cumulative estimated tax ramifications associated with multiple financial transactions designated as business financial transactions.

21. The method for providing an intuitive and interactive financial transaction categorization display of claim 19 wherein the estimated tax ramifications display region data generates an estimated tax ramifications display region within the uncategorized financial transaction display that includes data indicating the estimated tax ramifications associated with the current financial transaction designated as business financial transaction.

22. A method for providing an intuitive and interactive personal and business travel categorization display comprising:
defining personal and business travel categories;
obtaining travel data representing one or more trips associated with a user;
processing the travel data in accordance with rules data representing one or more automated categorization rules to generate a categorized portion of the travel data representing travel categorized according to the rules data as being in either the personal or business travel categories and an uncategorized portion of the travel data representing travel not categorized according to the rules data as being in either the personal or business travel categories;
generating uncategorized travel display data for generating an uncategorized travel display, the uncategorized travel display data including uncategorized travel listing data for generating a listing of the uncategorized travel represented by the uncategorized portion of the travel data, the uncategorized travel display data also including personal or business travel categorization display regions data for defining personal or business uncategorized travel display regions within the uncategorized travel display, the personal uncategorized travel display region being associated with the personal travel category and the business uncategorized travel display region being associated with the business travel category;
using the uncategorized travel display data to generate and provide an uncategorized travel display to the user on a display screen of a user computing system;
providing the user the capability to categorize the uncategorized travel represented by the uncategorized travel listing data of the uncategorized travel display data as either personal or business travel by selecting an uncategorized trip listed in the uncategorized travel display and making a sweeping motion to either the personal or business uncategorized travel display regions of the uncategorized travel display;
wherein a selected uncategorized trip moved to the personal region of the uncategorized travel display is automatically categorized as personal travel by transforming the portion of the uncategorized travel listing data representing the uncategorized trip to personal travel category categorized travel listing data representing the formerly uncategorized travel as personal travel category travel;
further wherein a selected uncategorized trip moved to the business region of the uncategorized travel display is automatically categorized as business related travel by transforming the portion of the uncategorized travel listing data representing the uncategorized trip to business travel category categorized travel listing data representing the formerly uncategorized trip as a business travel category trip.

23. The method for providing an intuitive and interactive personal and business travel categorization display of claim 22 wherein travel data representing travel associated with a user is obtained from a financial management system selected from the group of financial management systems consisting of:
a computing system implemented financial management system;
a network accessed financial management system;
a web-based financial management system; and
a cloud-based financial management system.

24. The method for providing an intuitive and interactive personal and business travel categorization display of claim 22 wherein the personal uncategorized travel display region and the business uncategorized travel display region are associated with a personal uncategorized travel display region graphic and a business uncategorized travel display region graphic selected from the group of uncategorized travel display region graphics consisting of:
a personal uncategorized travel display region graphic color associated the personal uncategorized travel display region and a business uncategorized travel display region graphic color associated with the business uncategorized travel display region;
a first color uncategorized travel display region pop-up graphic associated the personal uncategorized travel display region and a second color uncategorized travel display region pop-up graphic associated with the business uncategorized travel display region;
a personal uncategorized travel display region icon graphic associated the personal uncategorized travel display region and a business uncategorized travel display region icon graphic associated with the business uncategorized travel display region;
a personal uncategorized travel display region animated graphic associated the personal uncategorized travel display region and a business uncategorized travel display region animated graphic associated with the business uncategorized travel display region;
a personal uncategorized travel display region shaped graphic associated the personal uncategorized travel display region and a business uncategorized travel display region shaped graphic associated with the business uncategorized travel display region;
a personal uncategorized travel display region symbol graphic associated the personal uncategorized travel display region and a business uncategorized travel display region symbol graphic associated with the business uncategorized travel display region;
a personal uncategorized travel display region alpha-numeric graphic associated the personal uncategorized travel display region and a business uncategorized travel display region alpha-numeric graphic associated with the business uncategorized travel display region; and
a personal uncategorized travel display region avatar graphic associated the personal uncategorized travel display region and a business uncategorized travel display region avatar graphic associated with the business uncategorized travel display region.

25. The method for providing an intuitive and interactive personal and business travel categorization display of claim 22 wherein providing the user the capability to categorize the uncategorized travel represented by the uncategorized travel listing data of uncategorized travel display data by selecting an uncategorized trip listed in the uncategorized travel display and making a sweeping motion to either the personal or business region of the uncategorized travel display is performed via a single sweeping motion by the user on the display device of the user computing system.

26. The method for providing an intuitive and interactive personal and business travel categorization display of claim 25 wherein the single sweeping motion by the user on the display device of the user computing system is performed via the user's finger.

27. The method for providing an intuitive and interactive personal and business travel categorization display of claim 22 further comprising:
defining one or more personal travel sub-categories associated with the personal travel category and generating personal travel sub-category data;
mapping elements of personal travel category categorized travel listing data to personal travel sub-category data representing one or more of the one or more personal travel sub-categories;
wherein once the user categorizes a trip as personal travel by selecting an uncategorized trip listed in the uncategorized travel display and making a sweeping motion to the personal uncategorized travel display region of the uncategorized travel display, the portion of the travel data representing the personal travel category categorized trip is processed to identify a match with a portion of the personal travel sub-category data representing one or more of the one or more personal travel sub-categories;
further wherein if a match is identified between the portion of the travel data representing the personal travel category categorized travel and a portion of the personal travel sub-category data representing one or more of the one or more personal travel sub-categories, the user is presented the matched personal travel sub-category as a categorization option.

28. The method for providing an intuitive and interactive personal and business travel categorization display of claim 22 further comprising:
defining one or more personal travel sub-categories associated with the personal travel category and generating personal travel sub-category data wherein once the user categorizes travel as a personal trip by selecting an uncategorized trip listed in the uncategorized travel display and making a sweeping motion to the personal uncategorized travel display region of the uncategorized travel display, the user is presented the personal travel sub-categories represented by the personal travel sub-category data as categorization options.

29. The method for providing an intuitive and interactive personal and business travel categorization display of claim 22 further comprising:
defining one or more business travel sub-categories associated with the business travel category and generating business travel sub-category data;
mapping elements of business travel category categorized travel listing data to business travel sub-category data representing one or more of the one or more business travel sub-categories;
wherein once the user categorizes a trip as business travel by selecting an uncategorized trip listed in the uncategorized travel display and making a sweeping motion to the business uncategorized travel display region of the uncategorized travel display, the portion of the travel data representing the business travel category categorized travel is processed to identify a match with a portion of the business travel sub-category data representing one or more of the one or more business travel sub-categories;
further wherein if a match is identified between the portion of the travel data representing the business travel category categorized travel and a portion of the business travel sub-category data representing one or more of the one or more business travel sub-categories, the user is presented the matched business travel sub-category as a categorization option.

30. The method for providing an intuitive and interactive personal and business travel categorization display of claim 22 further comprising:
defining one or more business travel sub-categories associated with the business travel category and generating business travel sub-category data;
wherein once the user categorizes a trip as business travel by selecting an uncategorized trip listed in the uncategorized travel display and making a sweeping motion to the business uncategorized travel display region of the uncategorized travel display, the user is presented the business travel sub-categories represented by the business travel sub-category data as categorization options.

31. The method for providing an intuitive and interactive personal and business travel categorization display of claim 22 further comprising:
estimated tax ramifications display region data for generating an estimated tax ramifications display region within the uncategorized travel display, the estimated tax ramifications display region including tax ramifications data indicating the tax ramifications associated with one or more trips designated as business travel.

32. The method for providing an intuitive and interactive personal and business travel categorization display of claim 31 wherein once the user categorizes a trip as business travel by selecting an uncategorized trip listed in the uncategorized travel display and making a sweeping motion to the business uncategorized travel display region of the uncategorized travel display, the portion of the travel data representing the business travel category categorized travel is processed to determine the estimated tax ramifications of the business travel category categorized travel and the estimated tax ramifications data is updated to reflect the estimated tax ramifications associated with the business travel category categorized travel.

33. The method for providing an intuitive and interactive personal and business travel categorization display of claim 32 wherein the estimated tax ramifications display region data generates an estimated tax ramifications display region within the uncategorized travel display that includes data indicating the cumulative estimated tax ramifications associated with multiple trips designated as business travel.

34. The method for providing an intuitive and interactive personal and business travel categorization display of claim 32 wherein the estimated tax ramifications display region data generates an estimated tax ramifications display region within the uncategorized travel display that includes data indicating the estimated tax ramifications associated with the current trip designated as business travel.
